(19) United States
(12) Patent Application Publication
(10) Pub. No.: US 2023/0258957 A1
(43) Pub. Date: Aug. 17, 2023

(54) QUANDRANTNOPIAL OCCLUSIVE LENSES

(71) Applicant: David Rosenthal, Carrollton, TX (US)

(72) Inventor: David Rosenthal, Carrollton, TX (US)

(21) Appl. No.: 18/109,302

(22) Filed: Feb. 14, 2023

Related U.S. Application Data
(60) Provisional application No. 63/311,097, filed on Feb. 17, 2022.

(51) Int. Cl. G02C 7/02

(52) U.S. Cl. CPC G02C 7/02; G02C 2202/06

(57) ABSTRACT

A kit of eyewear that comprises a plurality of eyewear elements, each having a frame and a lens associated with each eye. Each of the eyewear elements have an occluded portion of at least one lens; at least some of the eyewear elements having different occlusion areas on the left and right lenses; and the eyewear elements having different occlusions patterns from each other.

### CROSS-REFERENCE TO RELATED APPLICATIONS

This application claims the benefit of U.S. Provisional Patent Application No. 63/311,097, filed on Feb. 17, 2022, entitled “QUANDRANTNOPIAL OCCLUSIVE LENSES”, which is hereby incorporated by reference in its entirety for all that is taught and disclosed therein.

### FIELD OF THE INVENTION

The present invention relates to lenses and the occlusion of the visual system.

### BACKGROUND AND SUMMARY

Occlusion of the visual system is sometimes needed by athletes, those who struggle with neurological diseases, and those looking to improve their overall brain performance.

Occlusion limits information from a specific visual field that connects with a corresponding region of the brain. This visual information would otherwise reach the brain and create a demand on the brain to either interpret or inhibit that incoming visual information.

The above disadvantages are addressed by a kit of eyewear that comprises a plurality of eyewear elements, each having a frame and a lens associated with each eye. Each of the eyewear elements have an occluded portion of at least one lens; at least some of the eyewear elements having different occlusion areas on the left and right lenses; and the eyewear elements having different occlusions patterns from each other.

### BRIEF DESCRIPTION OF THE DRAWINGS

FIG. 1 shows a basic lens shape (68 mm between pupils).

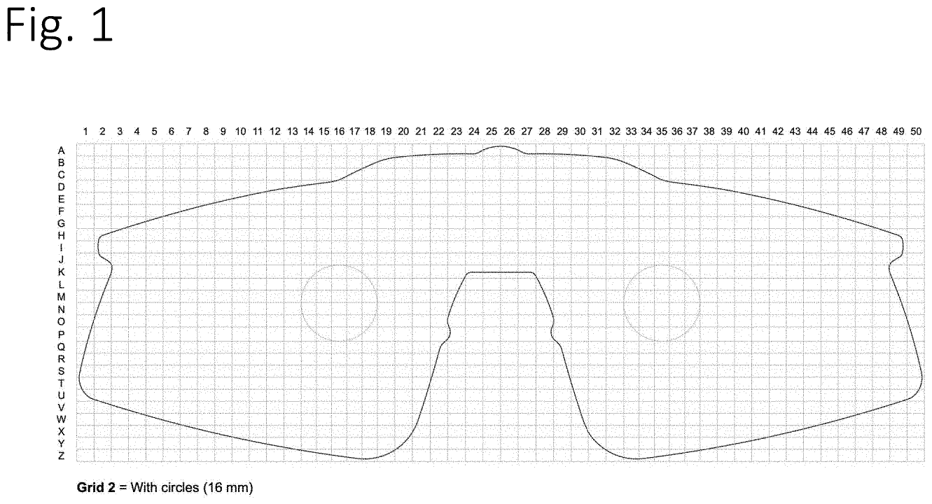

FIG. 2 shows a full bilateral occlusion.

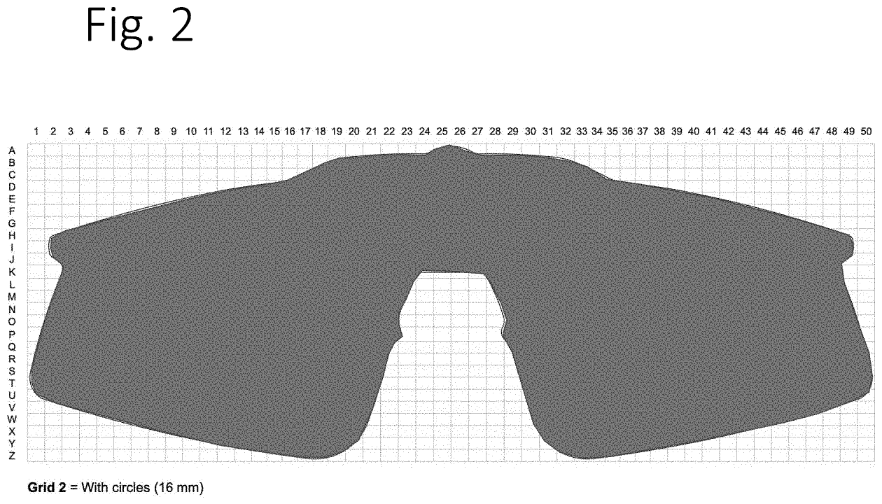

FIG. 3 shows a left eye occlusion.

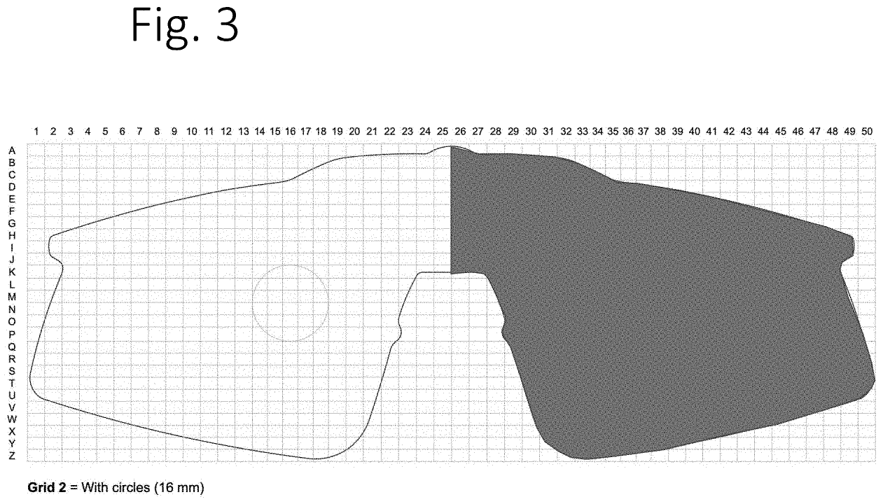

FIG. 4 shows a right eye occlusion.

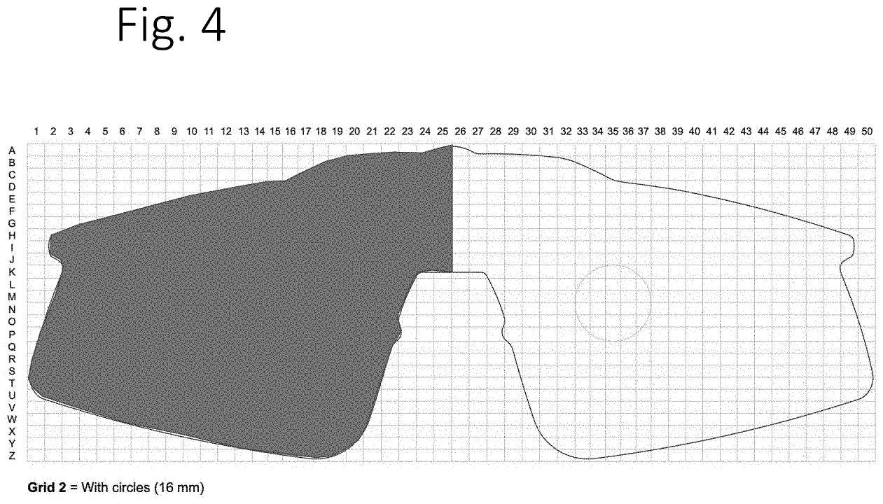

FIG. 5 shows both pupils occluded (small).

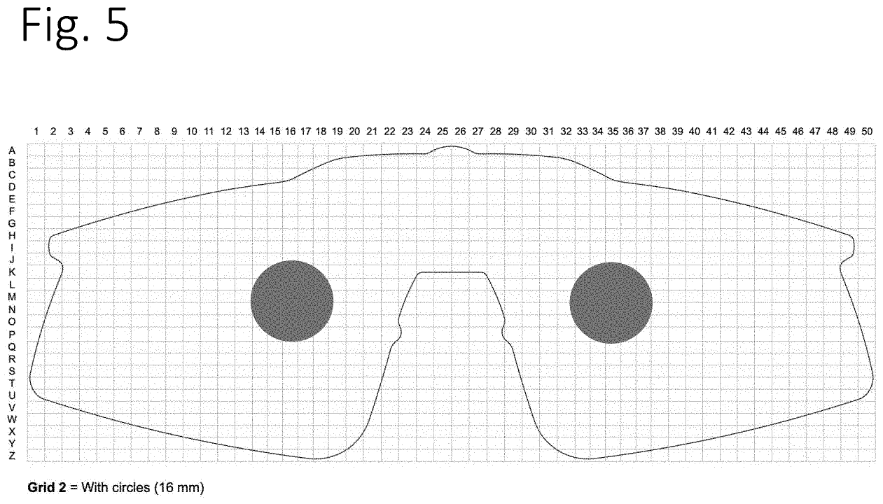

FIG. 6 shows right pupil occluded (small).

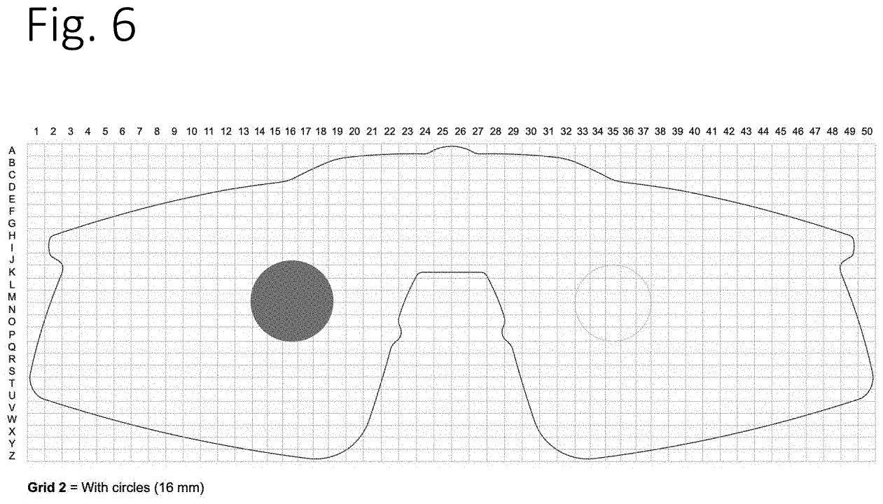

FIG. 7 shows left pupil occluded (small).

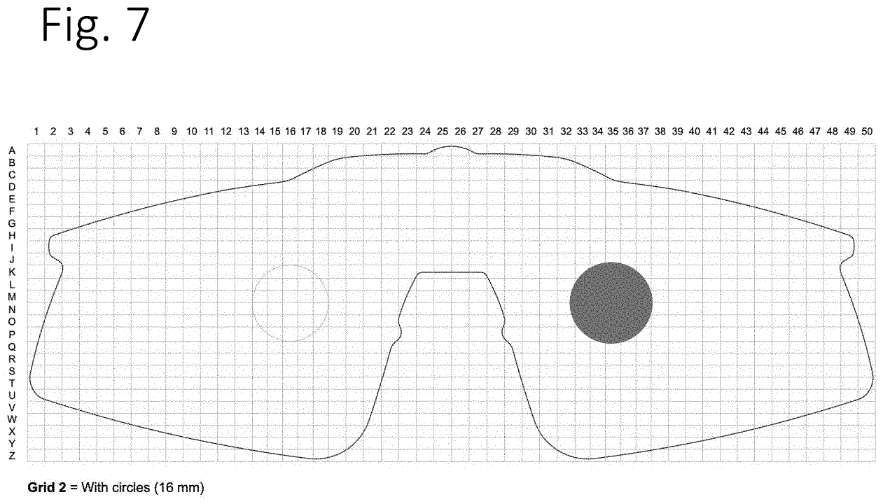

FIG. 8 shows both pupils occluded (medium).

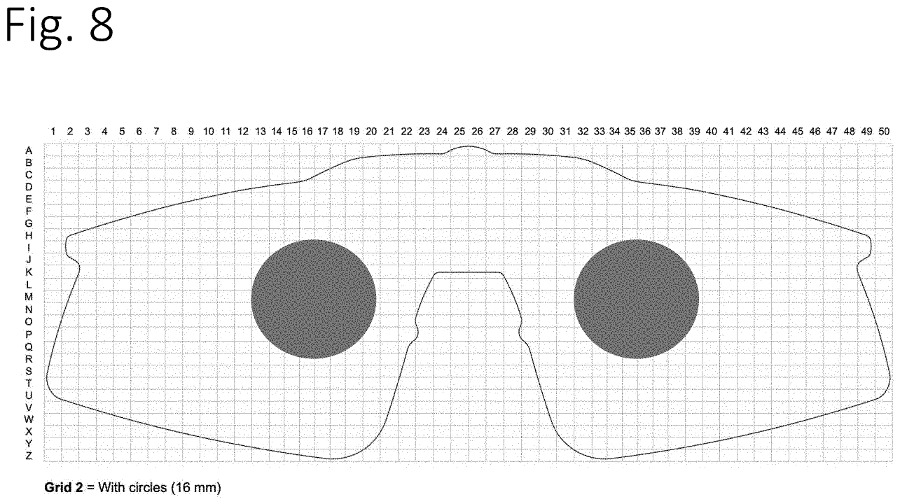

FIG. 9 shows right pupil occluded (medium).

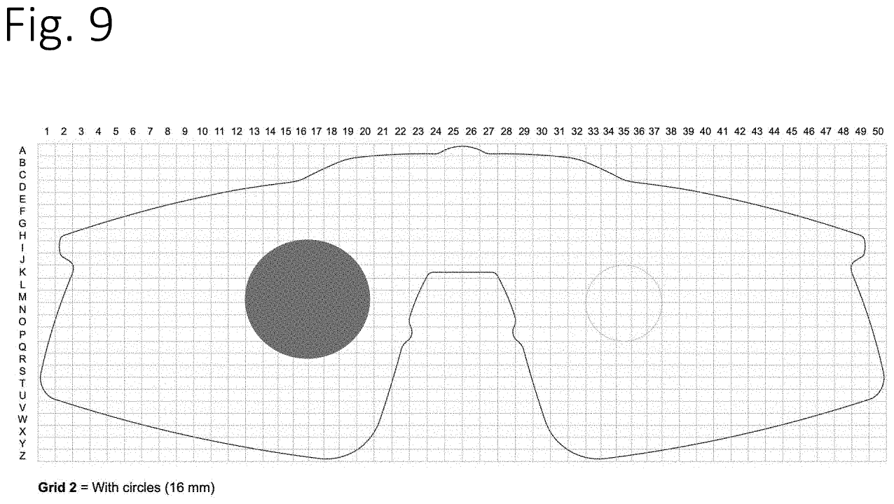

FIG. 10 shows left pupil occluded (medium).

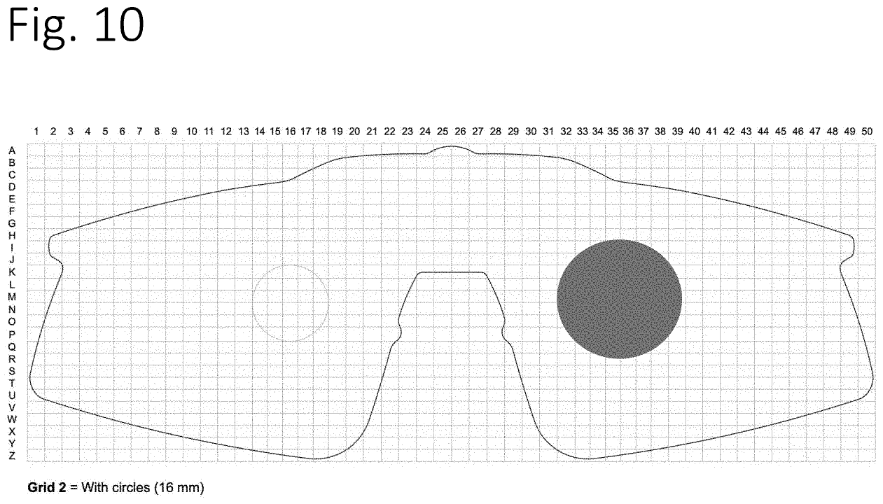

FIG. 11 shows both pupils occluded (large).

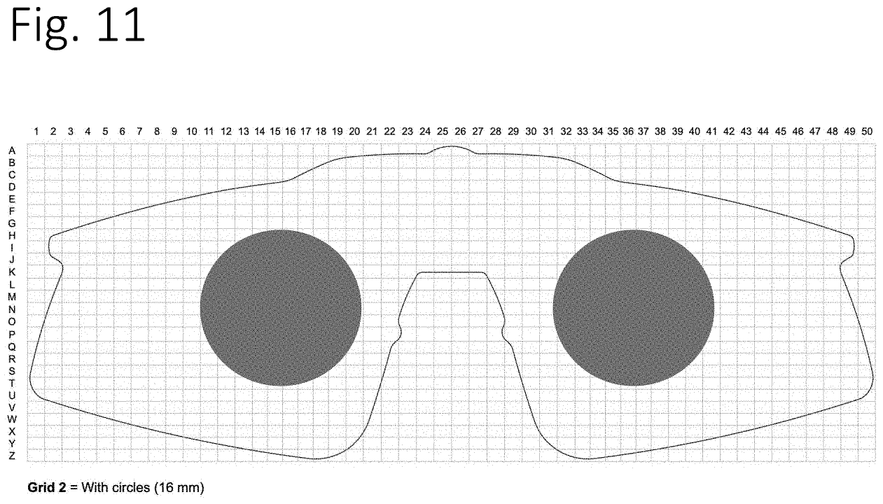

FIG. 12 shows right pupil occluded (large).

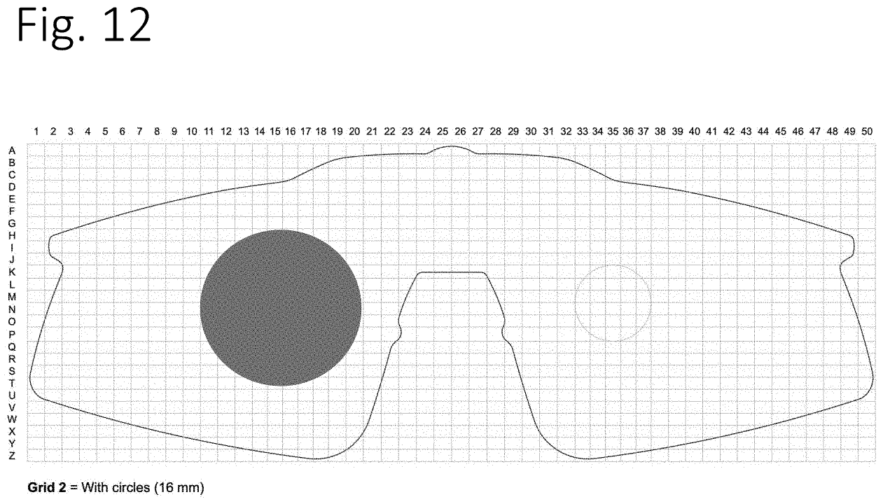

FIG. 13 shows left pupil occluded (large).

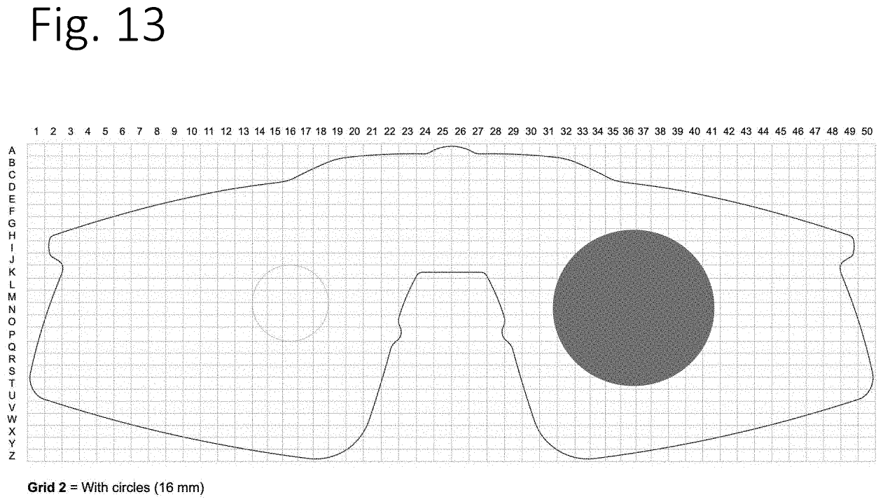

FIG. 14 shows bilateral open circle around pupil.

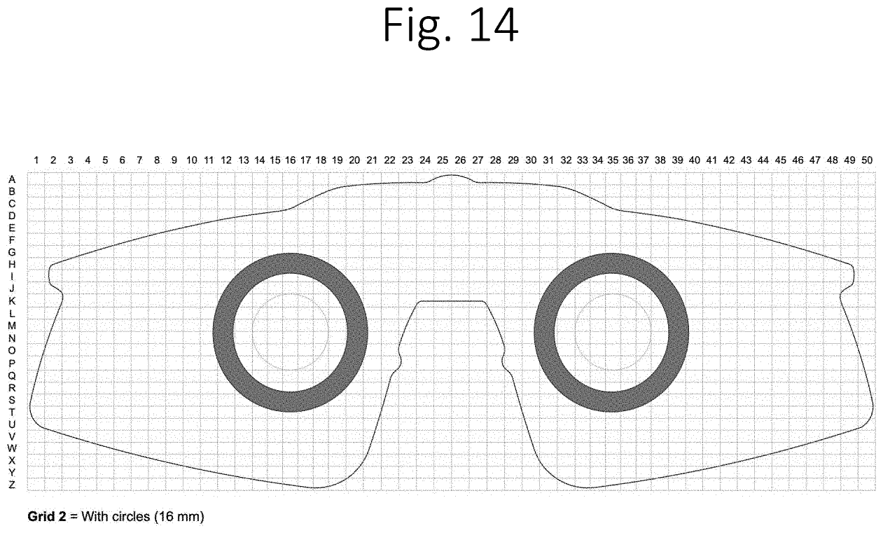

FIG. 15 shows right open circle around pupil.

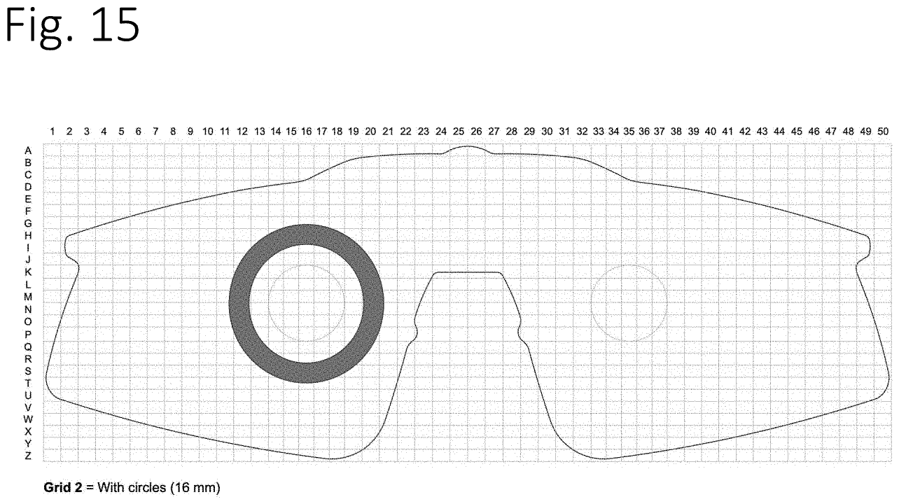

FIG. 16 shows left open circle around pupil.

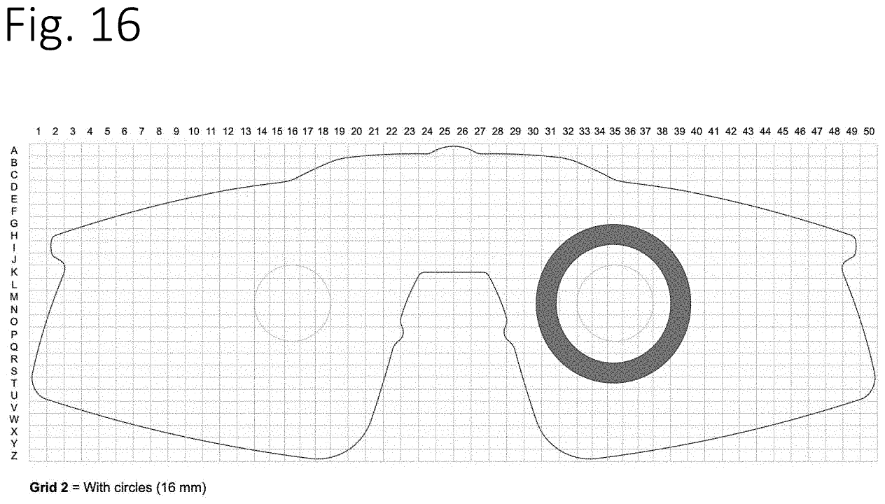

FIG. 17 shows bilateral large target symbol.

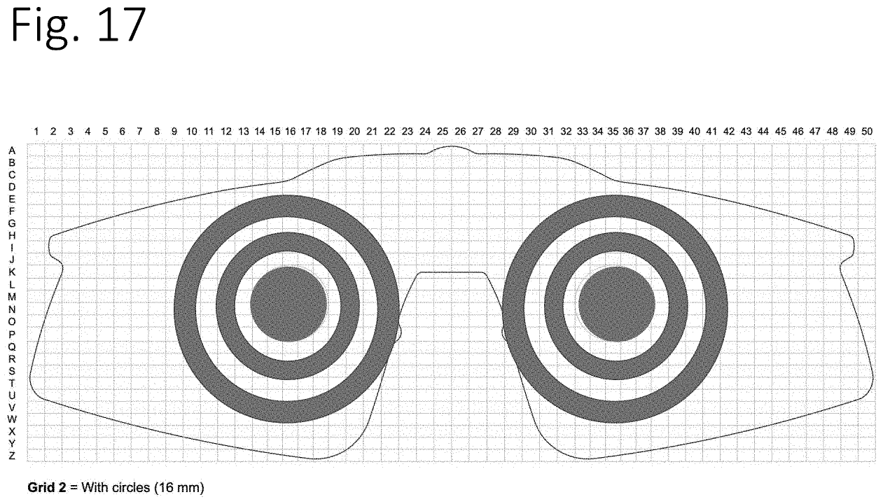

FIG. 18 shows right eye large target symbol.

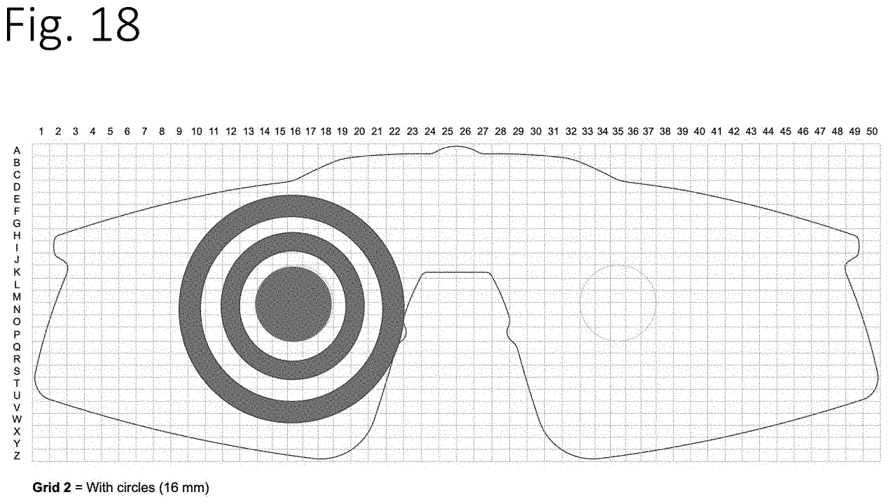

FIG. 19 shows left eye large target symbol.

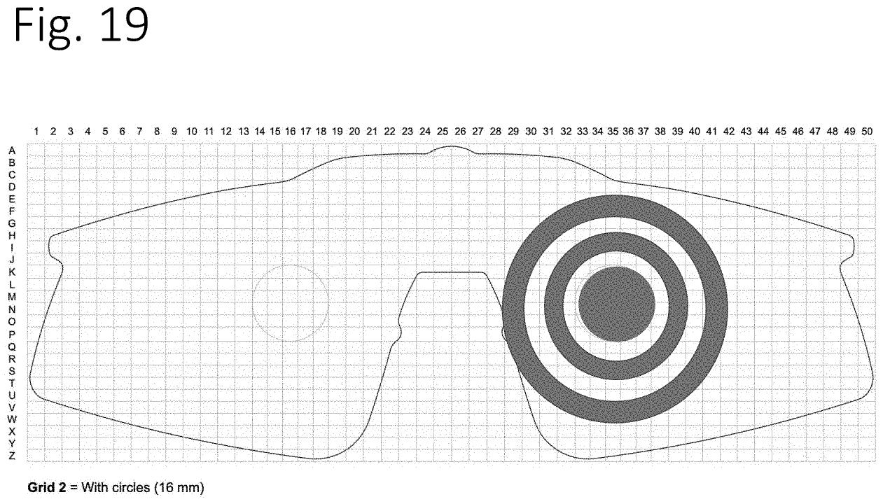

FIG. 20 shows bilateral medium target symbol.

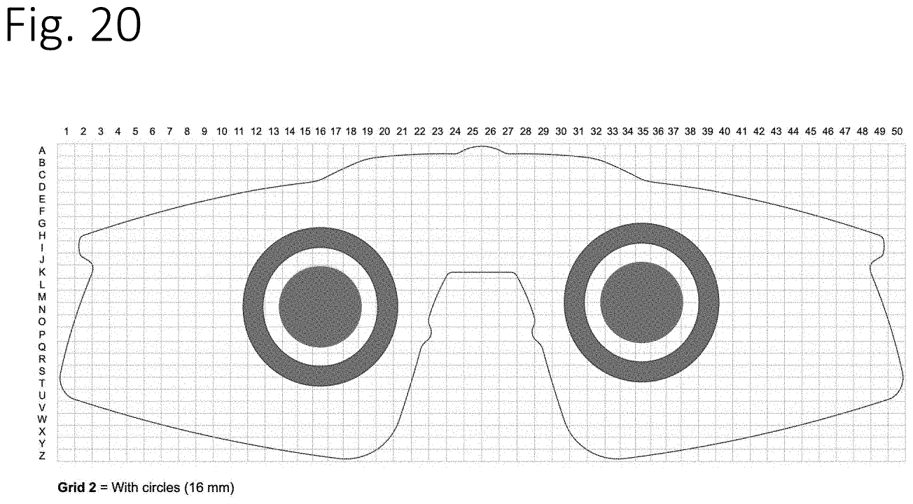

FIG. 21 shows right eye medium target symbol.

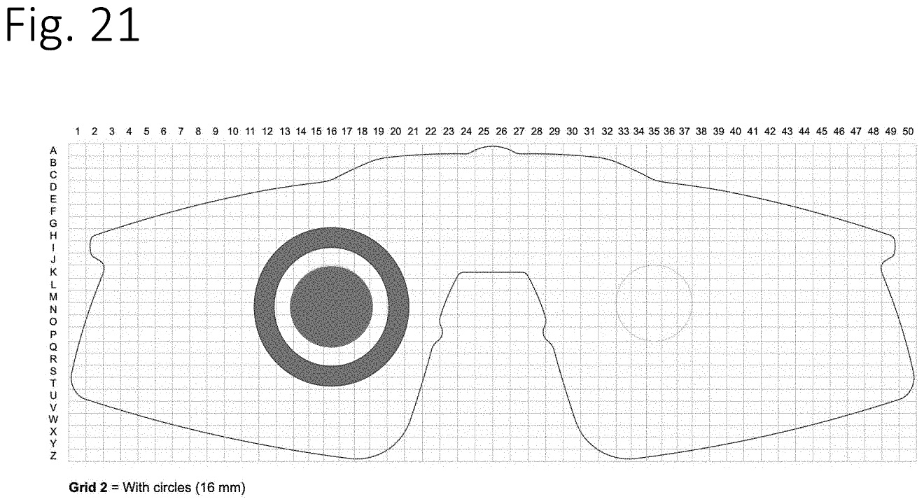

FIG. 22 shows left eye medium target symbol.

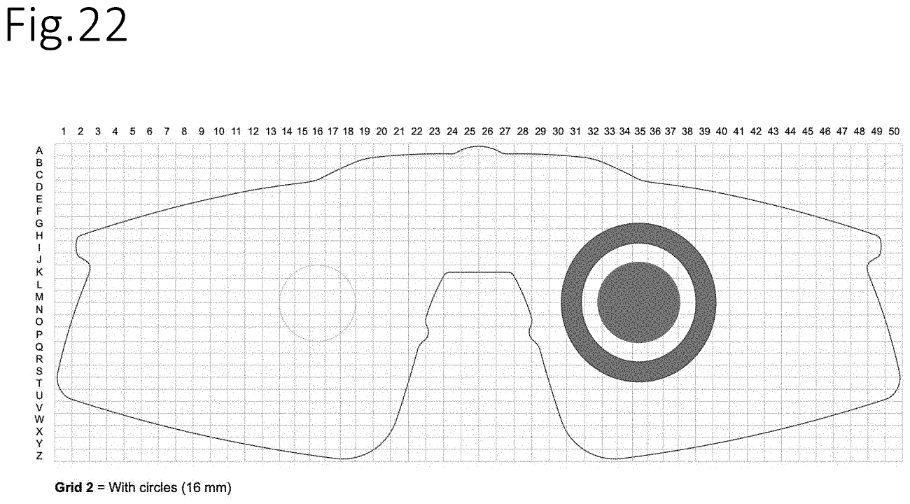

FIG. 23 shows bilateral small target symbol.

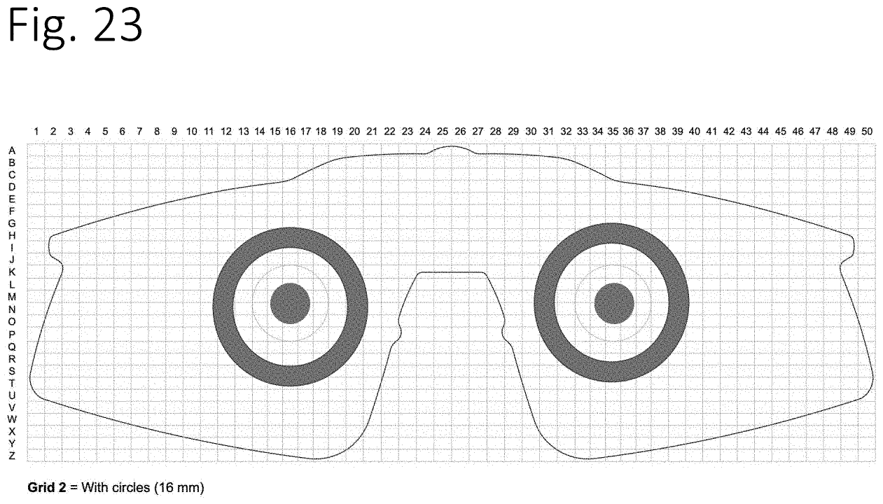

FIG. 24 shows right eye small target symbol.

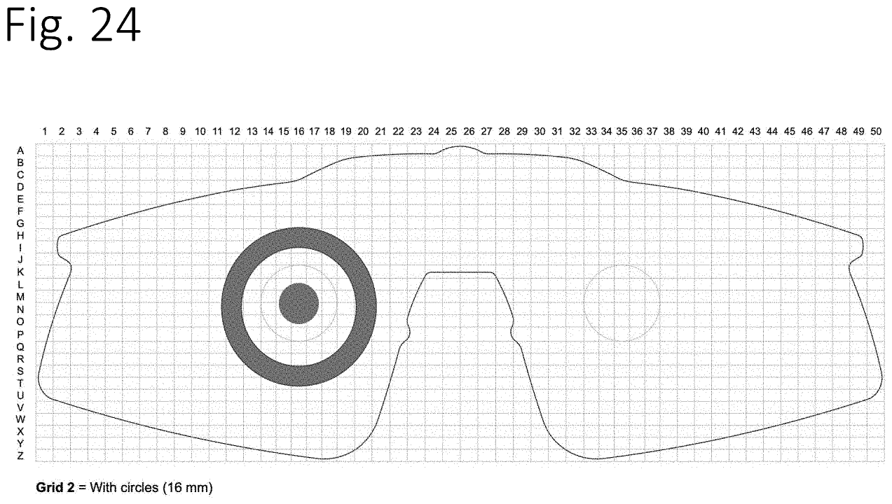

FIG. 25 shows left eye small target symbol.

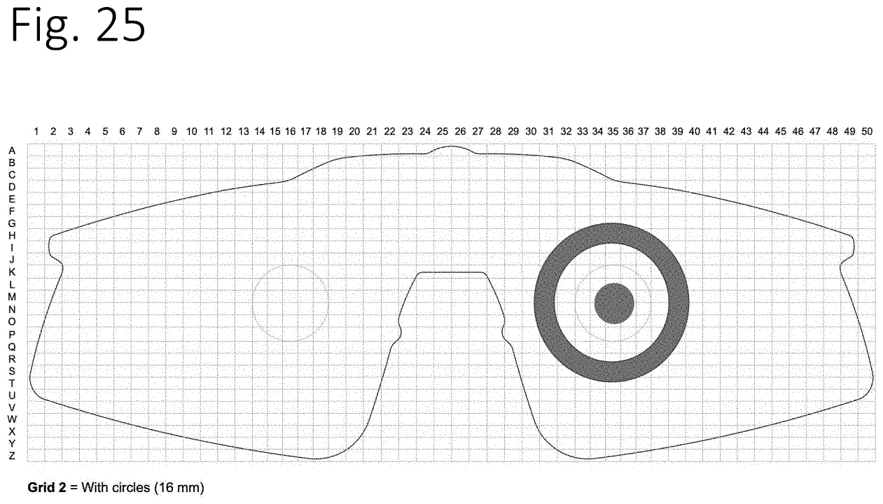

FIG. 26 shows bilateral temporal hemifield large.

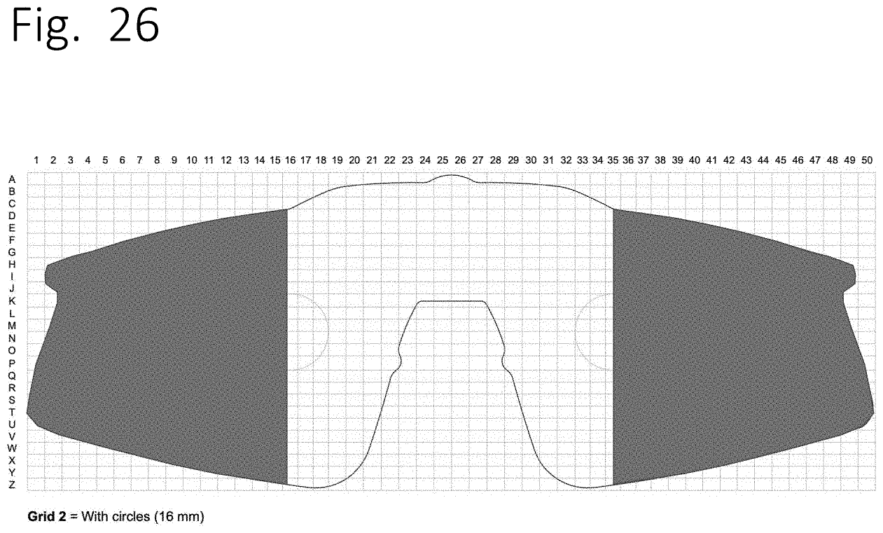

FIG. 27 shows right eye temporal hemifield large.

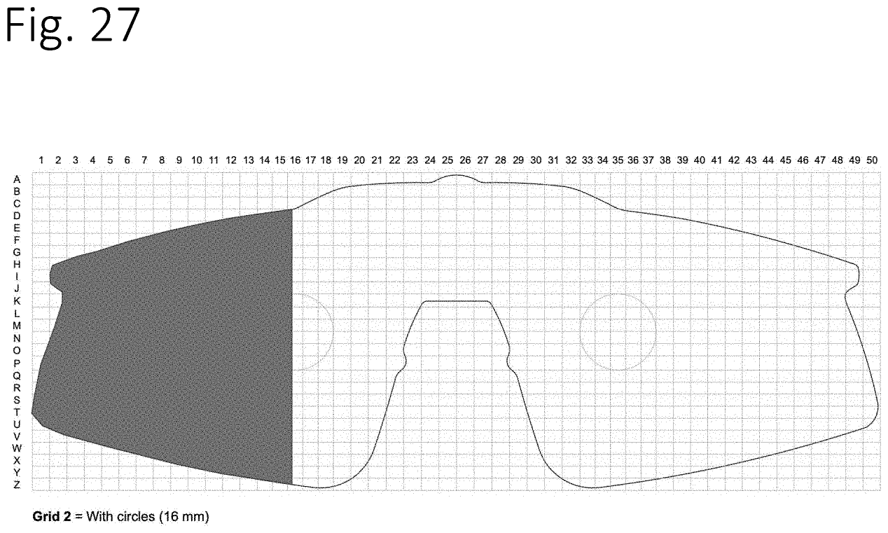

FIG. 28 shows left eye temporal hemifield large.

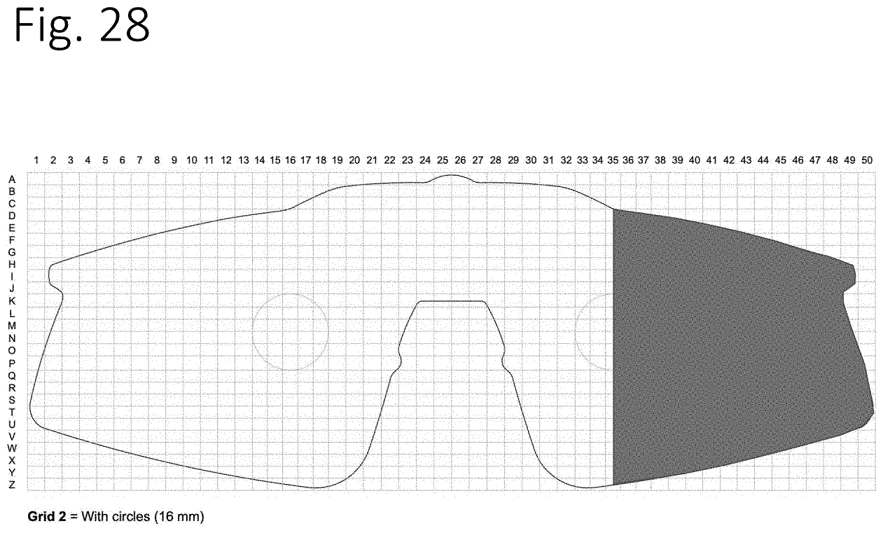

FIG. 29 shows bilateral temporal hemifield medium.

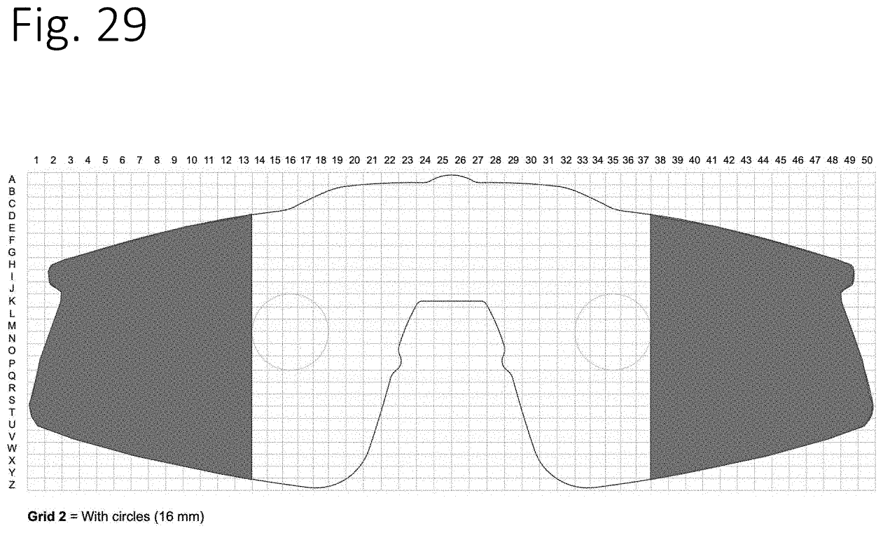

FIG. 30 shows right eye temporal hemifield medium.

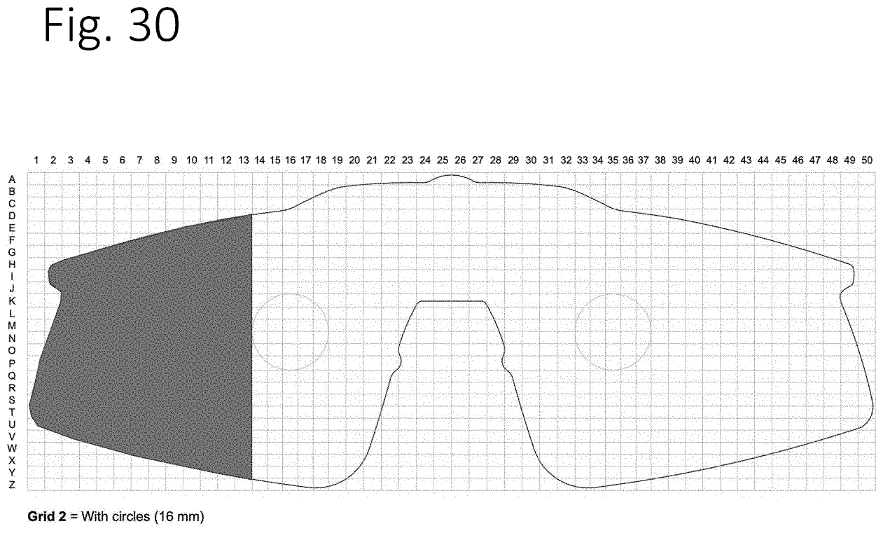

FIG. 31 shows left eye temporal hemifield medium.

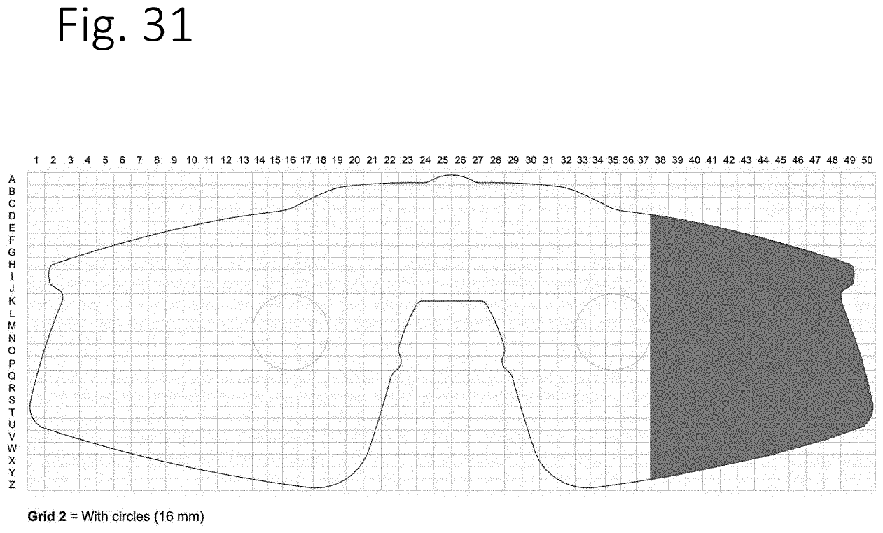

FIG. 32 shows bilateral temporal hemifield small.

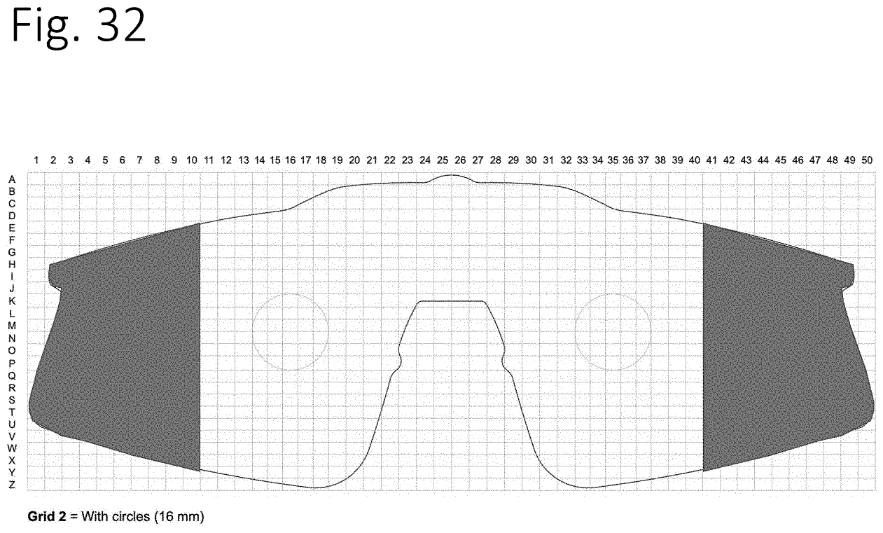

FIG. 33 shows right eye temporal hemifield small.

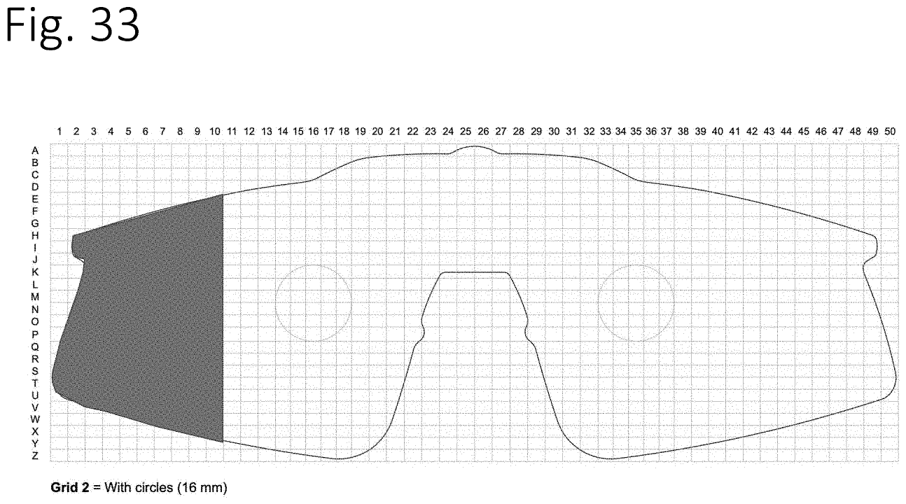

FIG. 34 shows left eye temporal hemifield small.

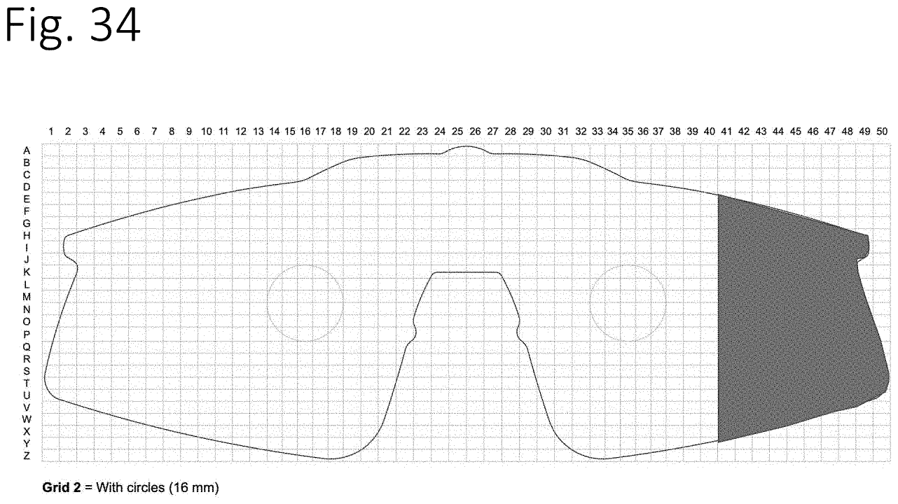

FIG. 35 shows bilateral nasal occlusion large.

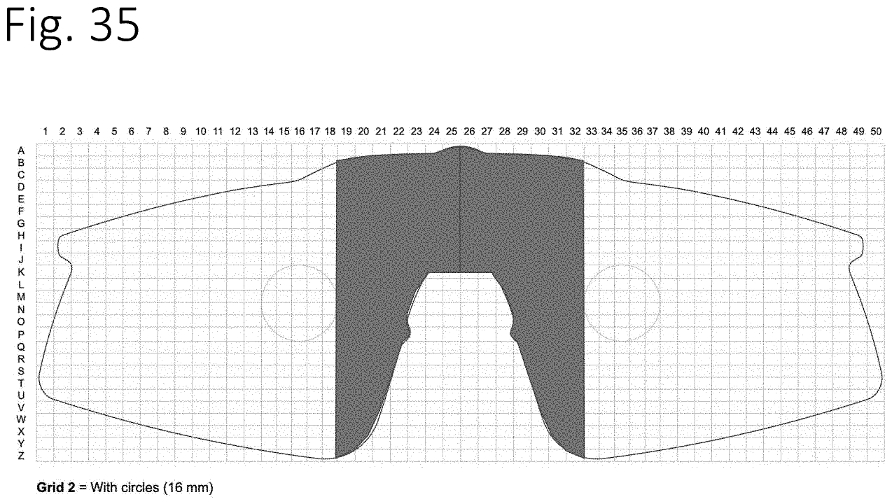

FIG. 36 shows right sided nasal occlusion large.

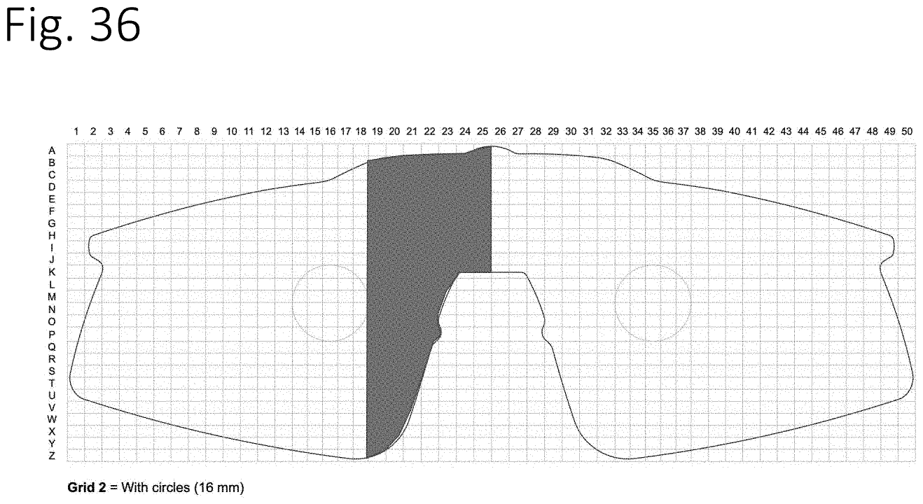

FIG. 37 shows left sided nasal occlusion large.

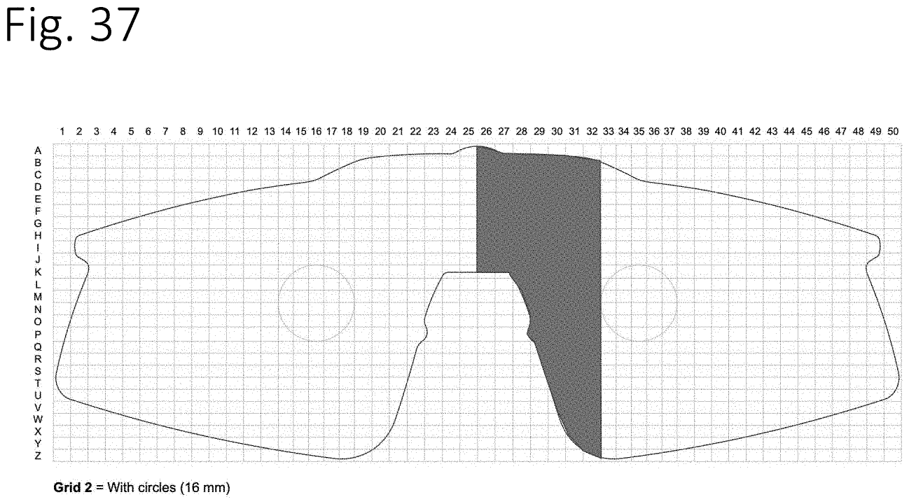

FIG. 38 shows bilateral nasal occlusion medium.

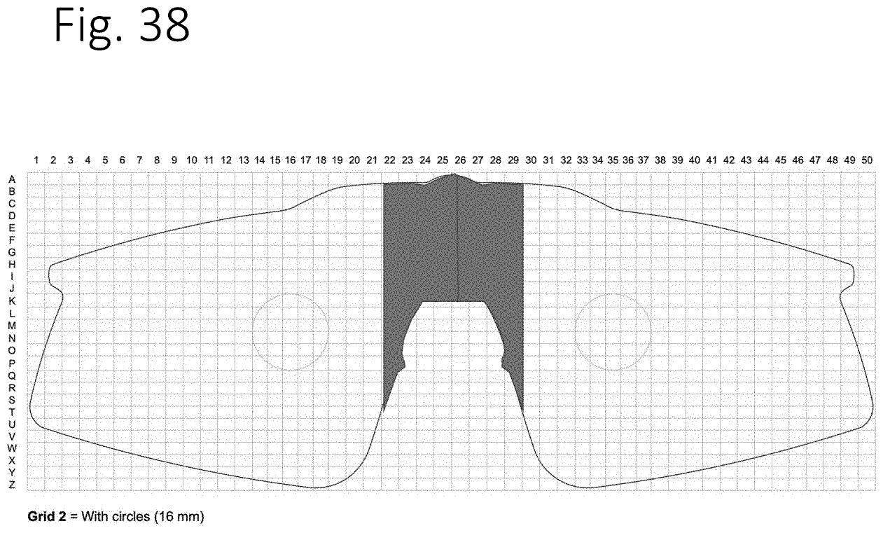

FIG. 39 shows right sided nasal occlusion medium.

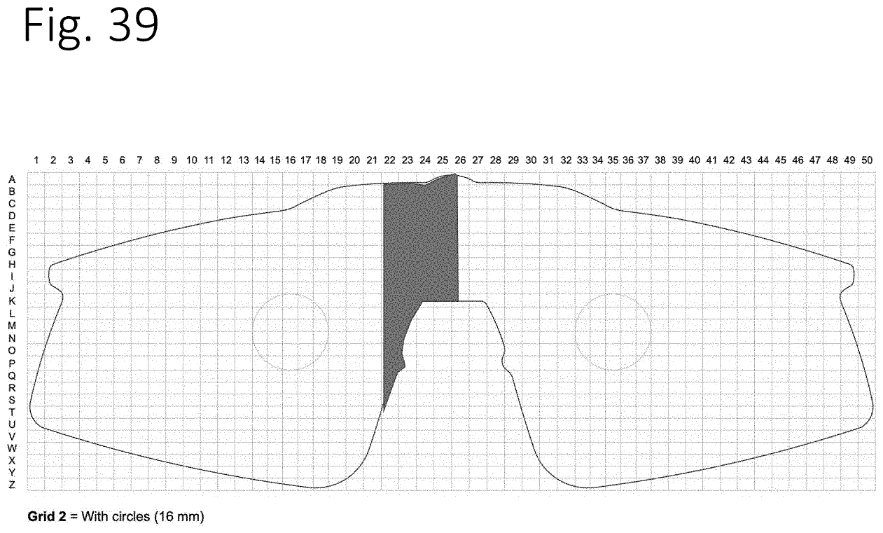

FIG. 40 shows left sided nasal occlusion medium.

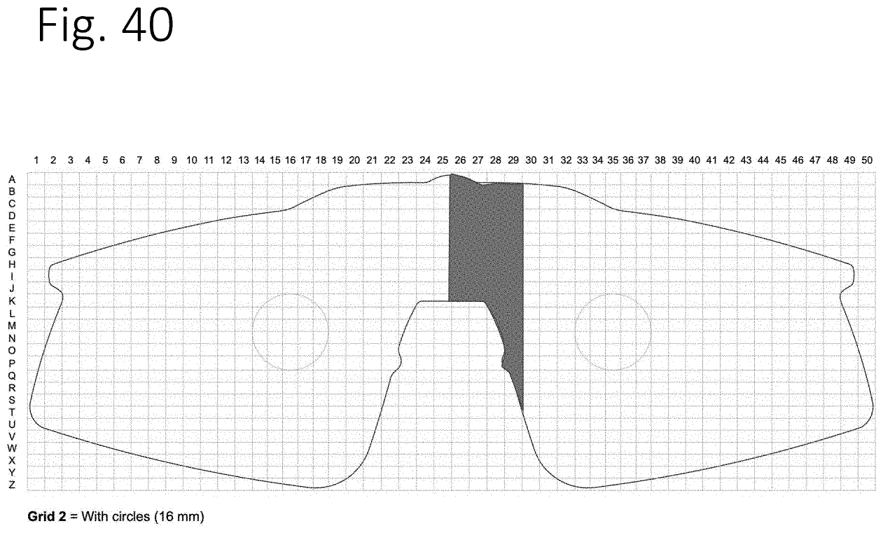

FIG. 41 shows bilateral nasal occlusion small.

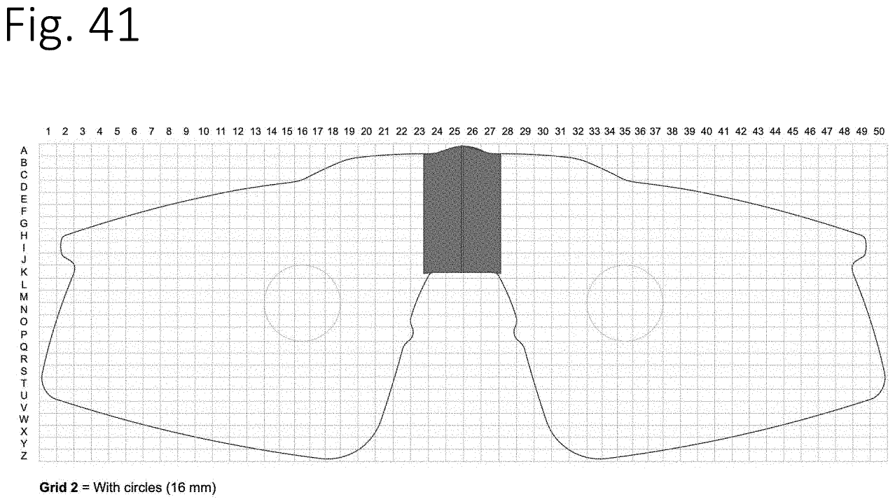

FIG. 42 shows right sided nasal occlusion small.

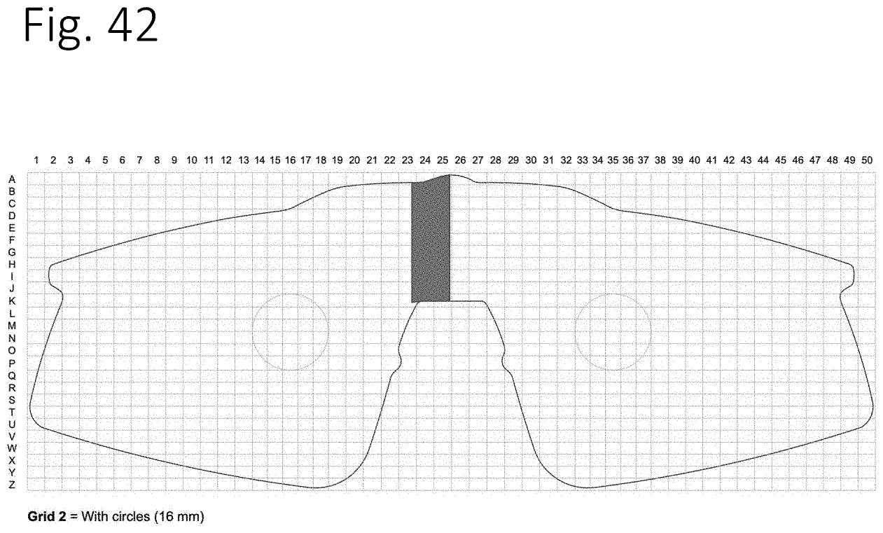

FIG. 43 shows left sided nasal occlusion small.

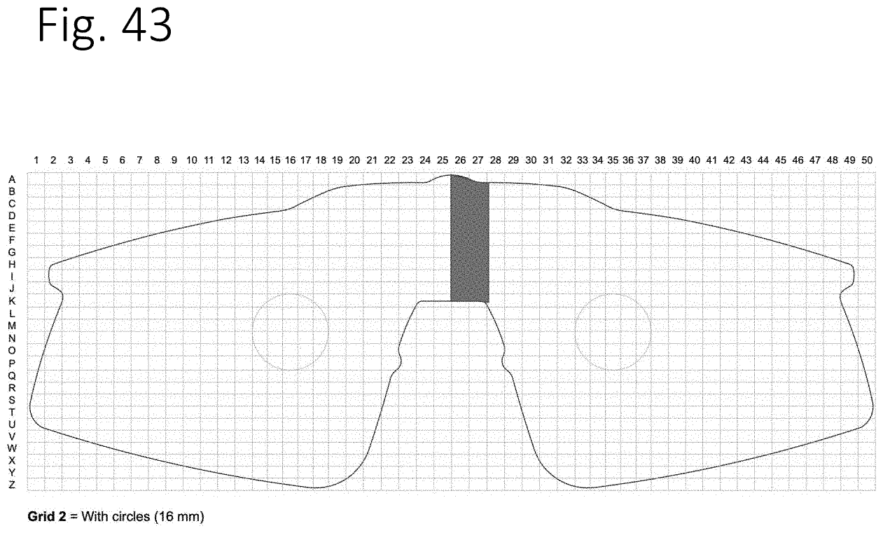

FIG. 44 shows bilateral inferior field occlusion large.

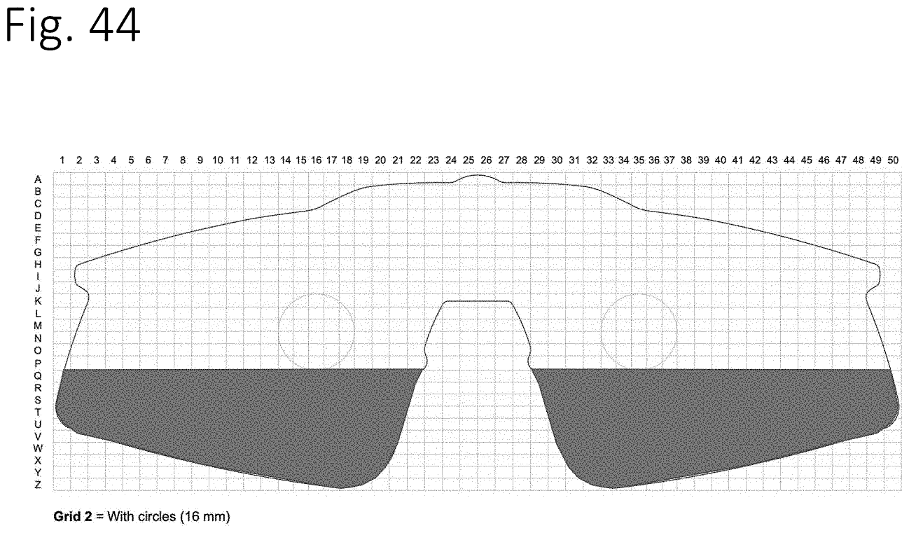

FIG. 45 shows right inferior field occlusion large.

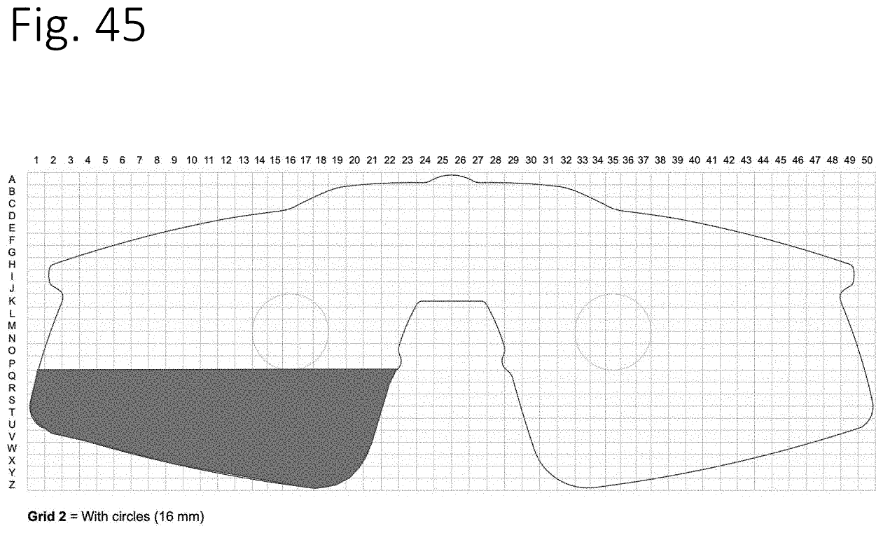

FIG. 46 shows left inferior field occlusion large.

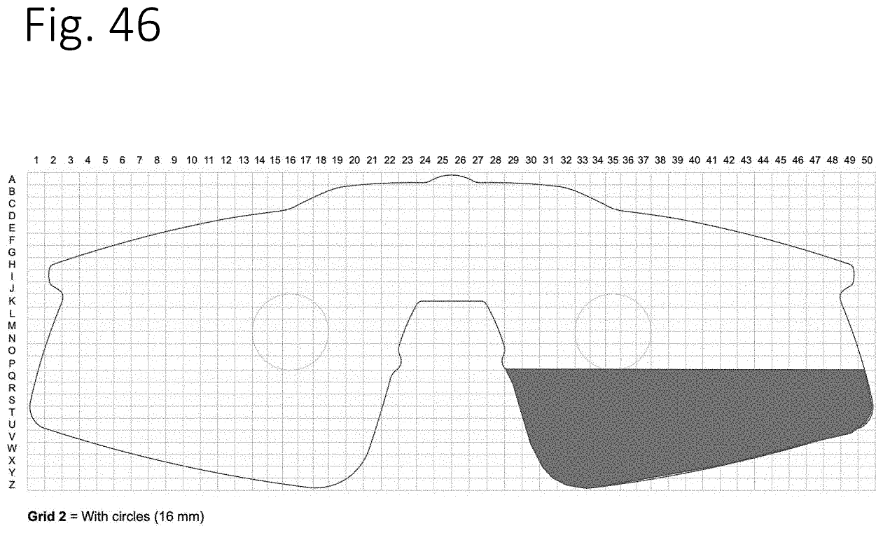

FIG. 47 shows bilateral inferior field occlusion medium.

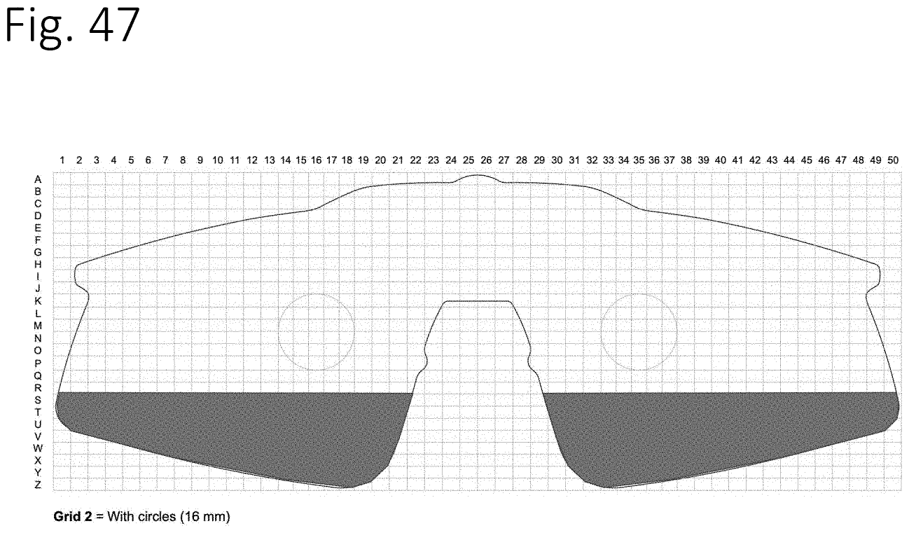

FIG. 48 shows right inferior field occlusion medium.

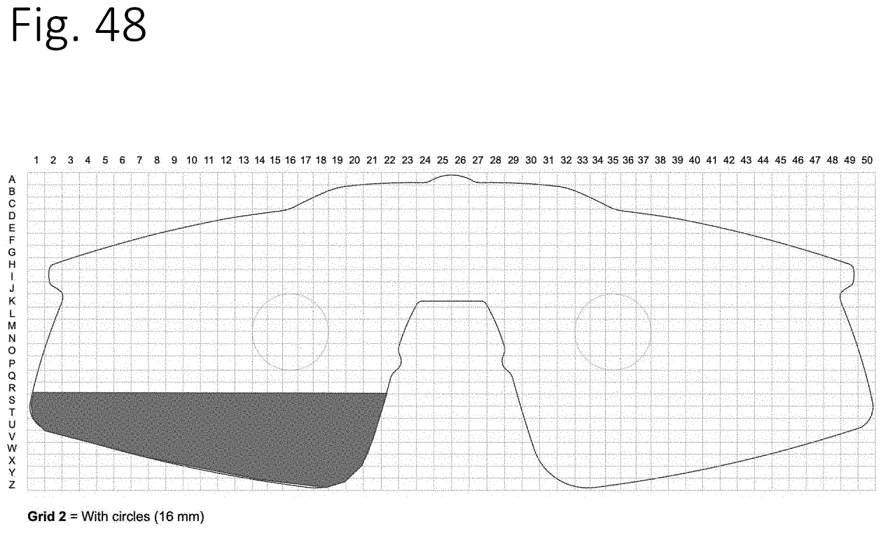

FIG. 49 shows left inferior field occlusion medium.

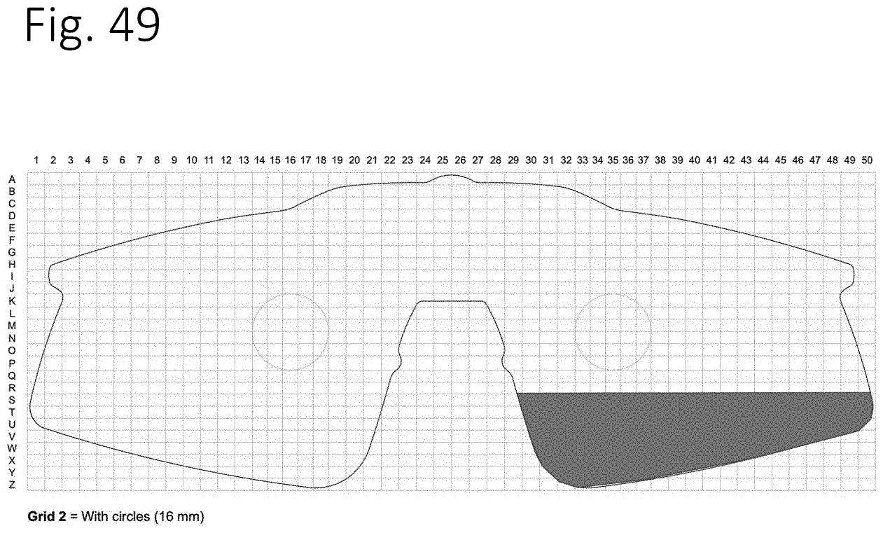

FIG. 50 shows bilateral inferior field occlusion small.

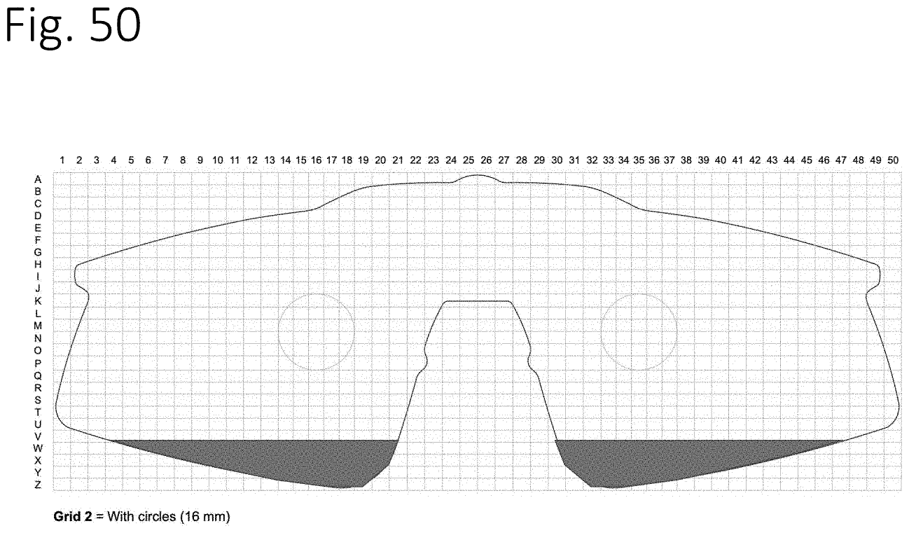

FIG. 51 shows right inferior field occlusion small.

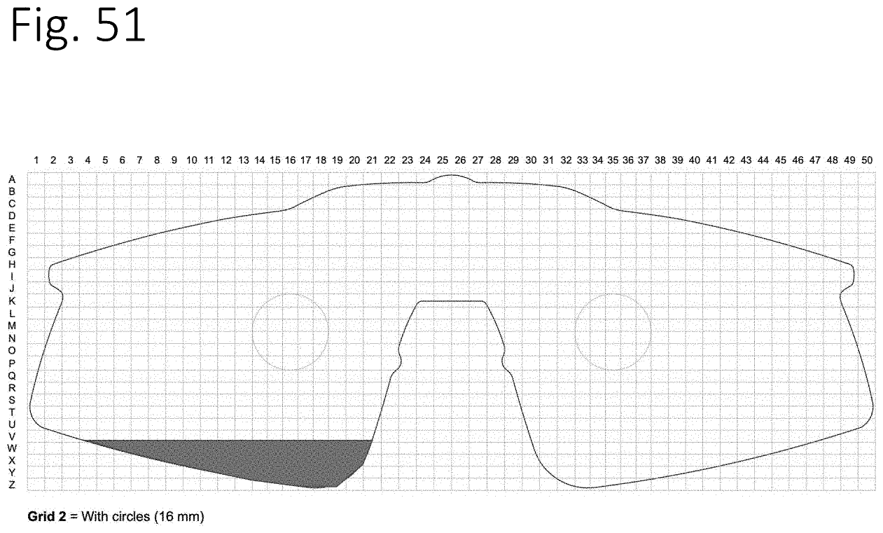

FIG. 52 shows left inferior field occlusion small.

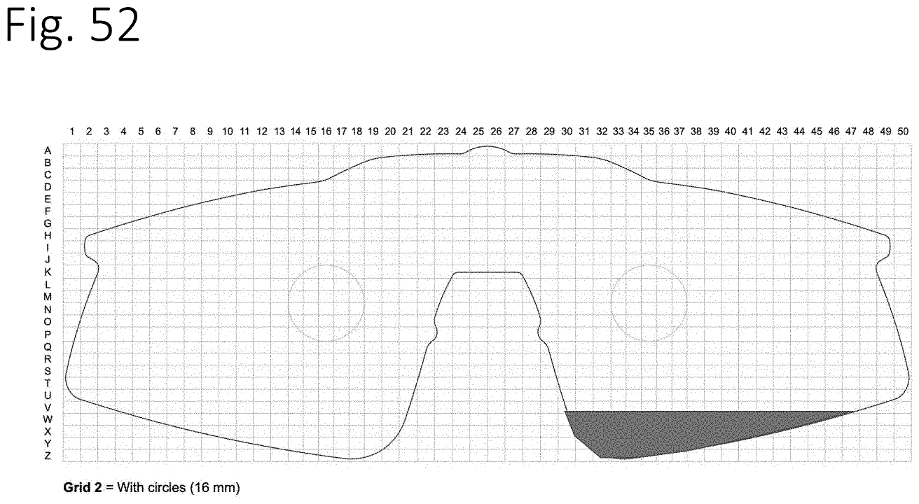

FIG. 53 shows bilateral superior field occlusion large.

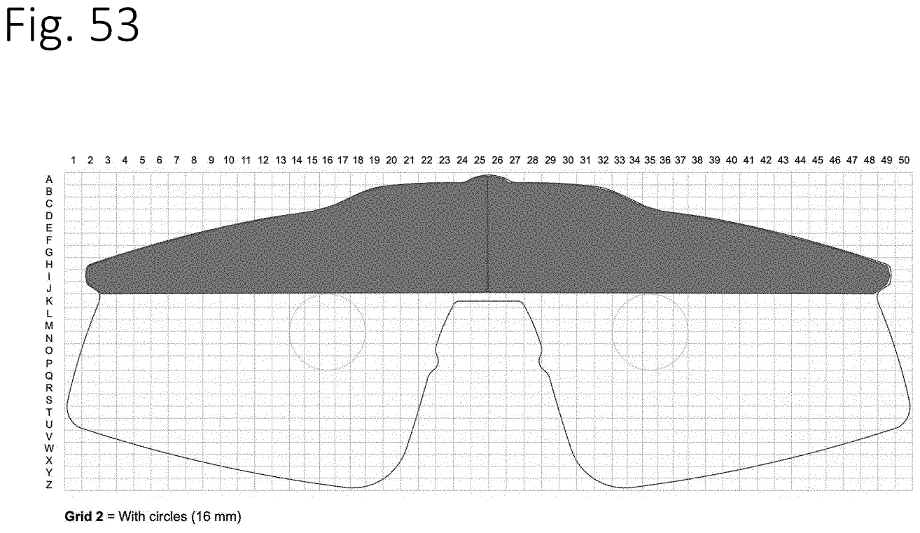

FIG. 54 shows right superior field occlusion large.

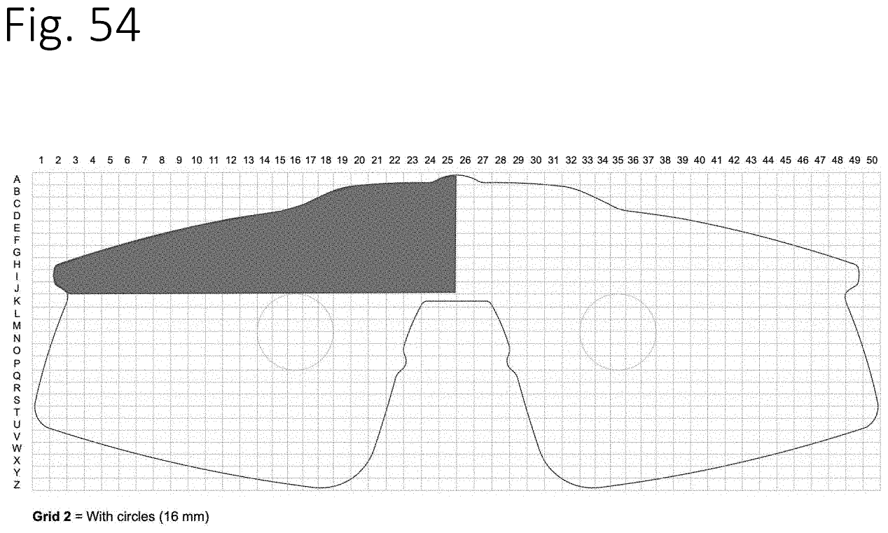

FIG. 55 shows left superior field occlusion large.

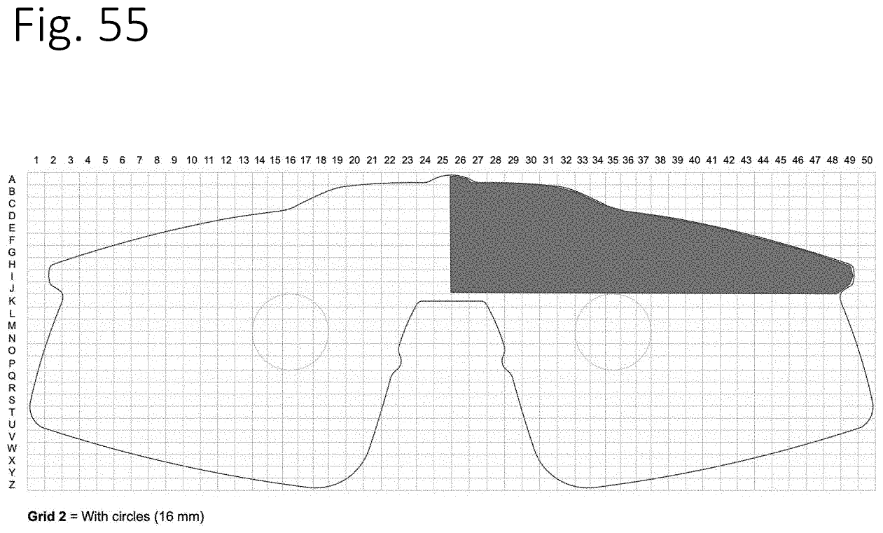

FIG. 56 shows bilateral superior field occlusion medium.

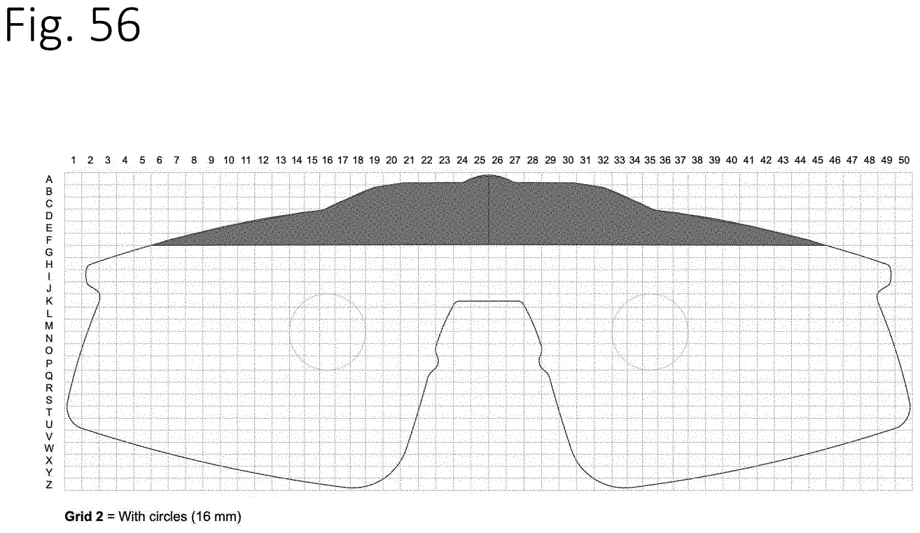

FIG. 57 shows right superior field occlusion medium.

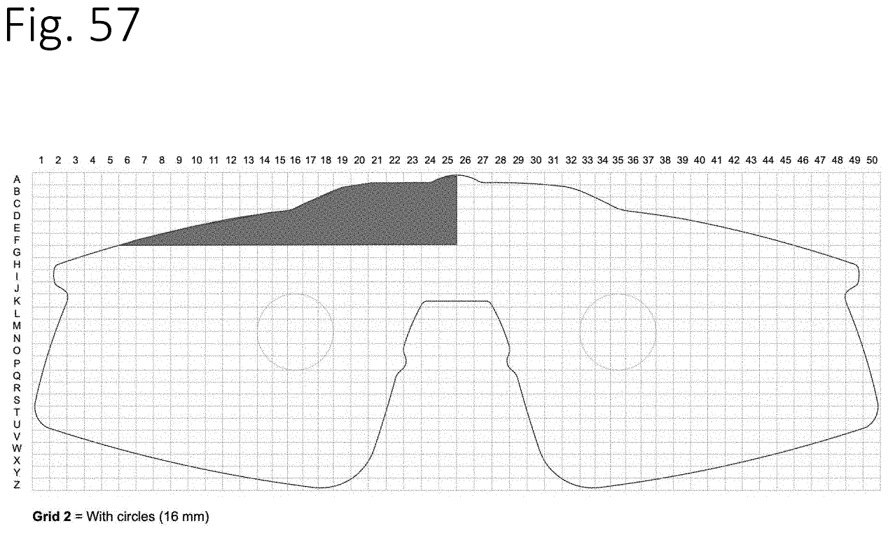

FIG. 58 shows left superior field occlusion medium.

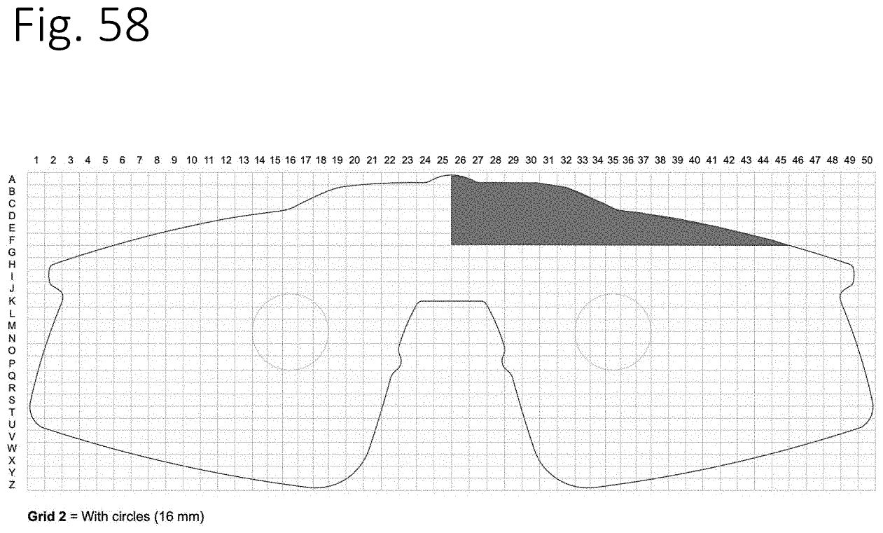

FIG. 59 shows bilateral superior field occlusion small.

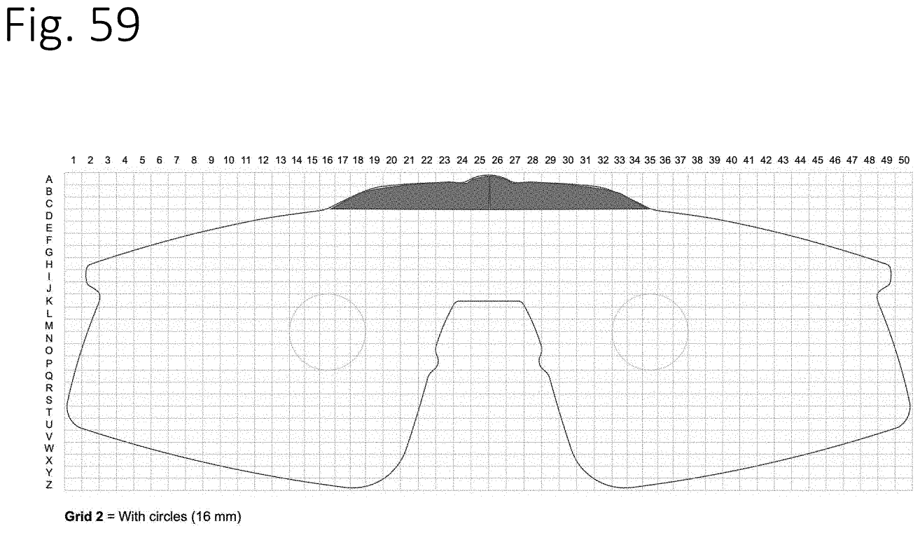

FIG. 60 shows right superior field occlusion small.

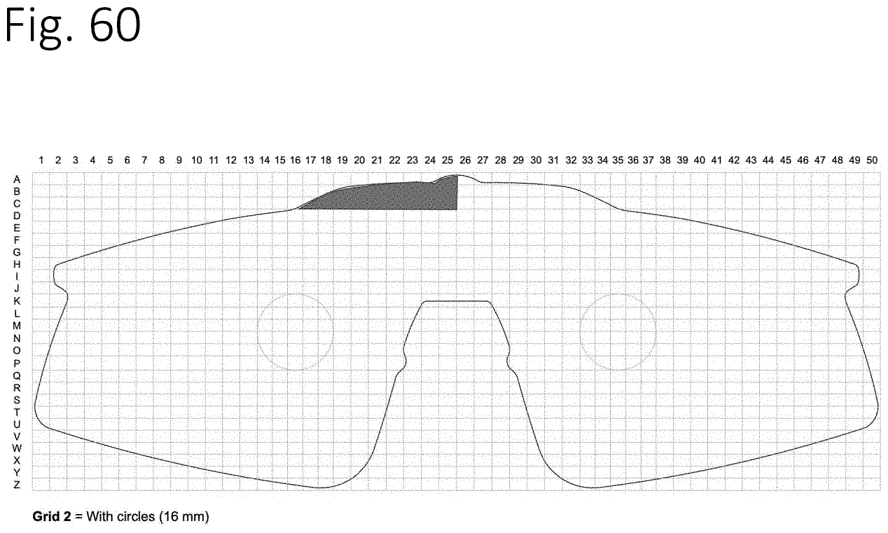

FIG. 61 shows left superior field occlusion small

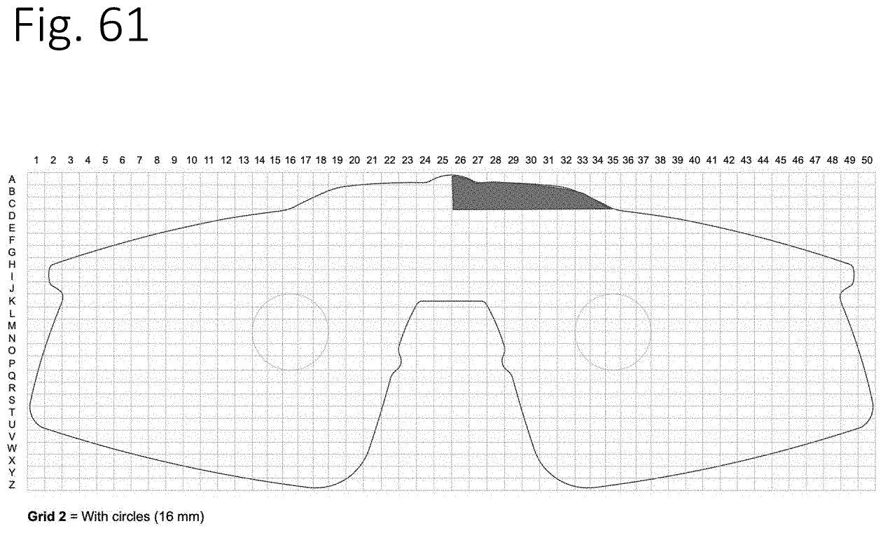

FIG. 62 shows bilateral vertical “yes” pattern large.

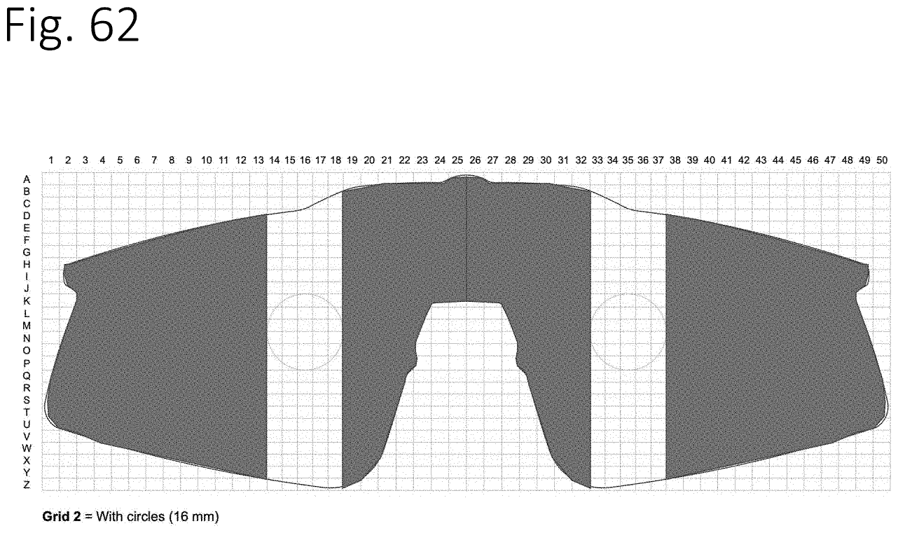

FIG. 63 shows bilateral vertical “yes” pattern medium.

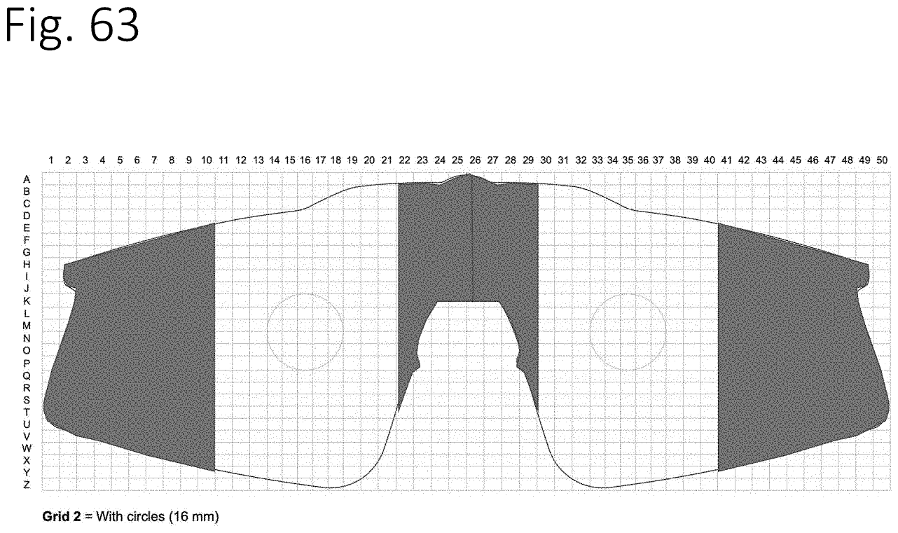

FIG. 64 shows bilateral vertical “yes” pattern small.

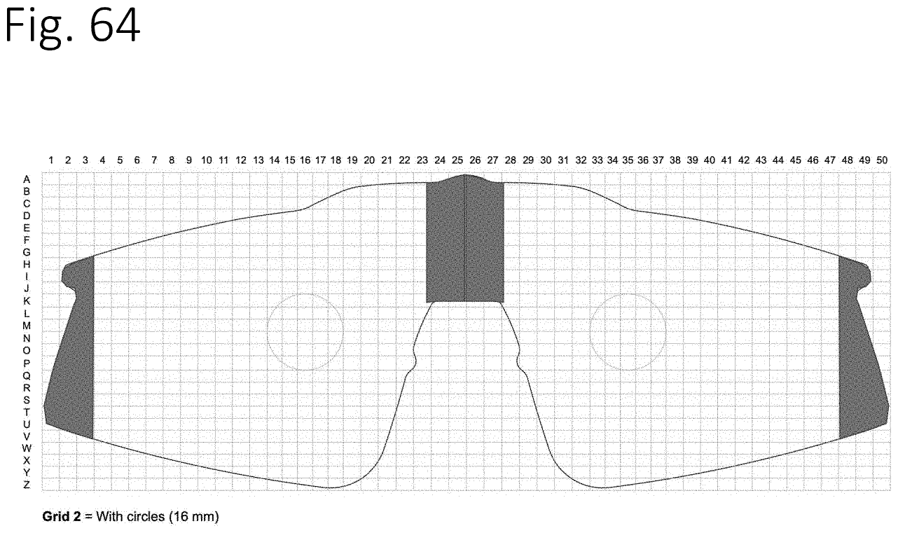

FIG. 65 shows bilateral vertical “no” pattern large.

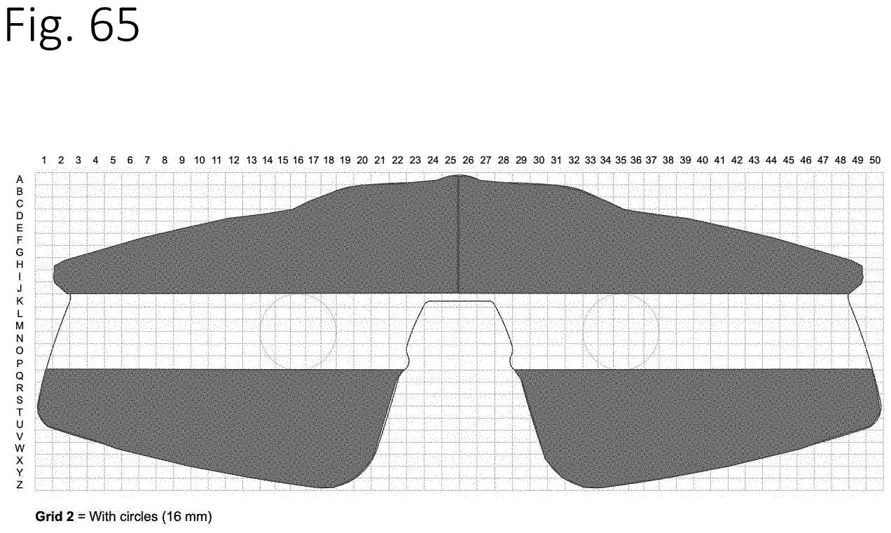

FIG. 66 shows bilateral vertical “no” pattern medium.

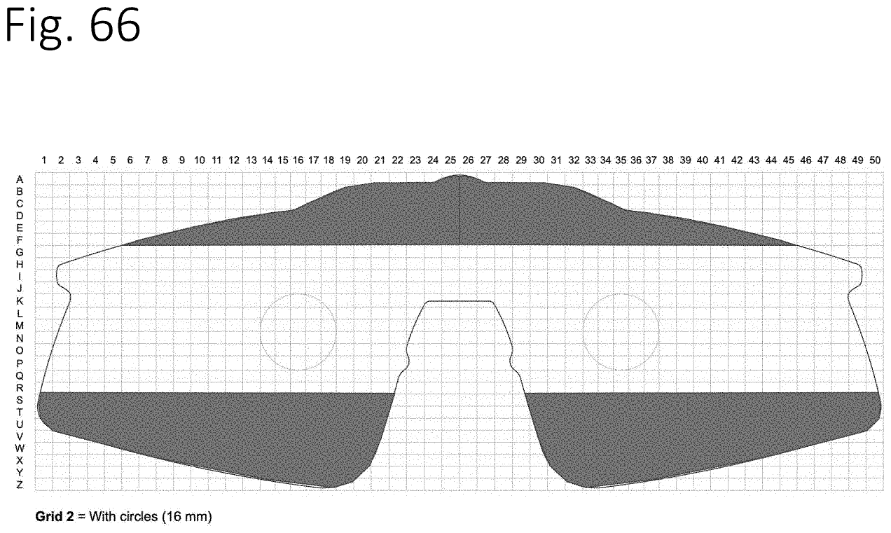

FIG. 67 shows bilateral vertical “no” pattern small.

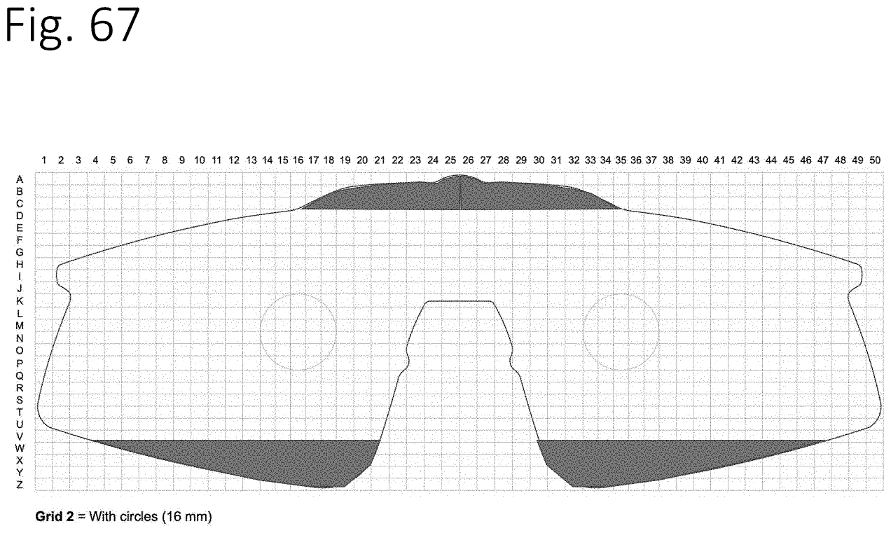

FIG. 68 shows right brain large.

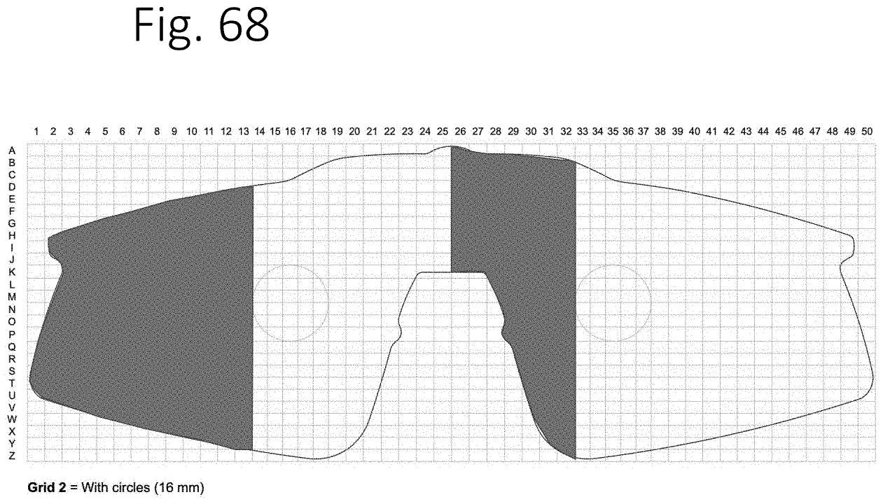

FIG. 69 shows right brain medium.

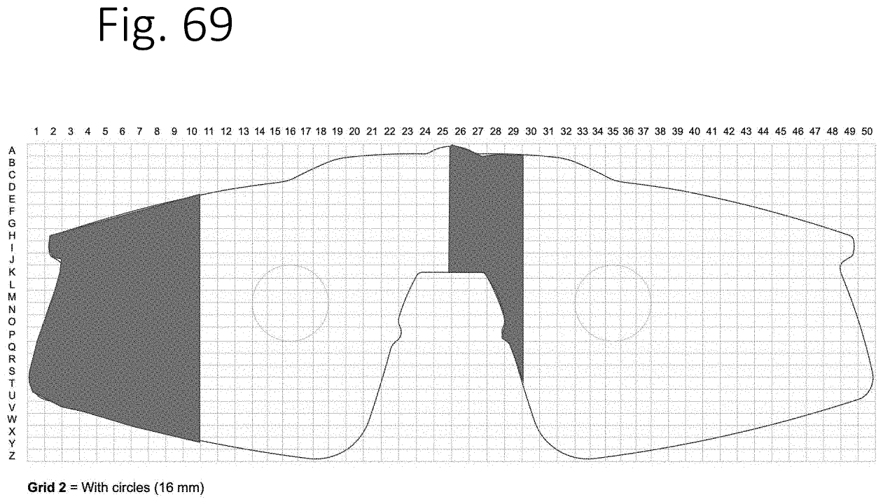

FIG. 70 shows right brain small.

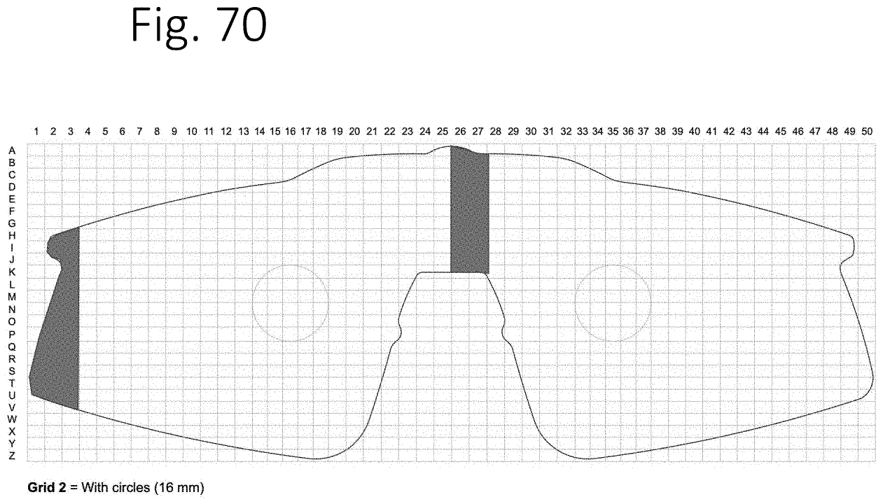

FIG. 71 shows left brain large.

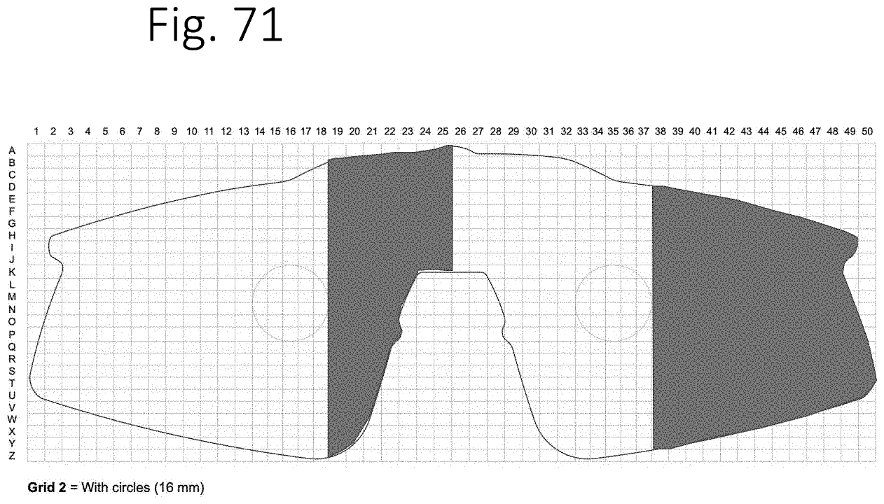

FIG. 72 shows left brain medium.

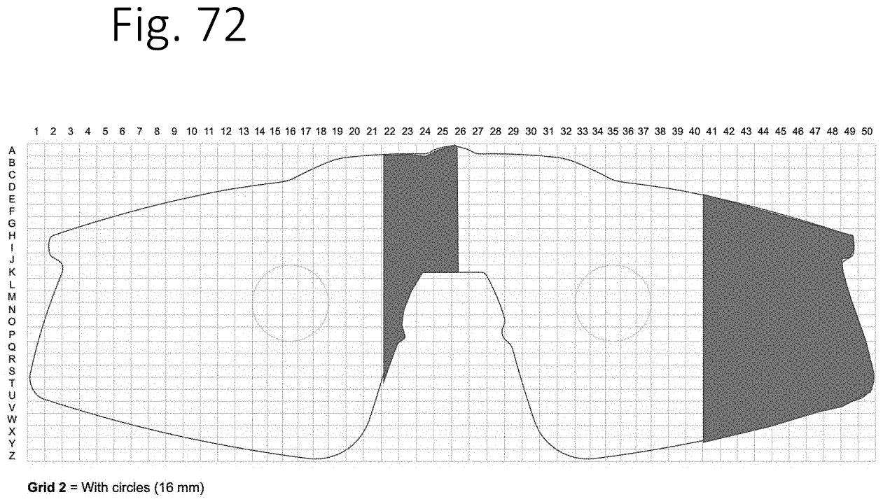

FIG. 73 shows left brain small.

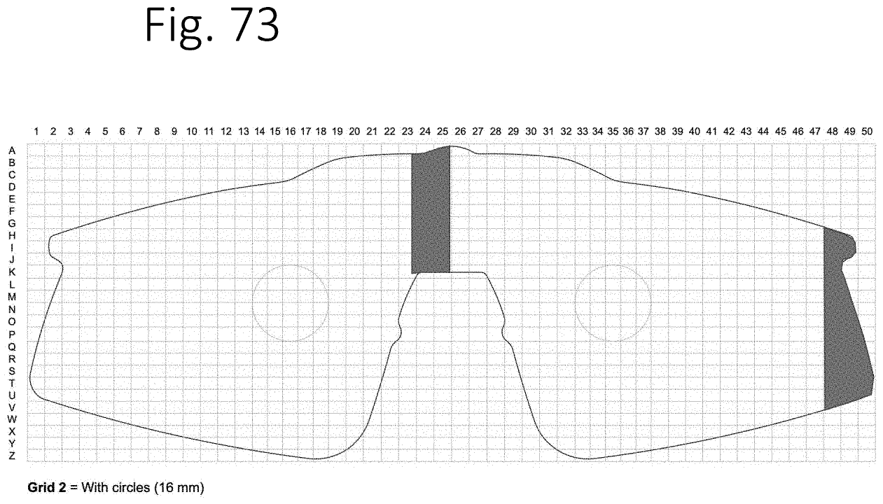

FIG. 74 shows bilateral full occlusion with bilateral central visual opening.

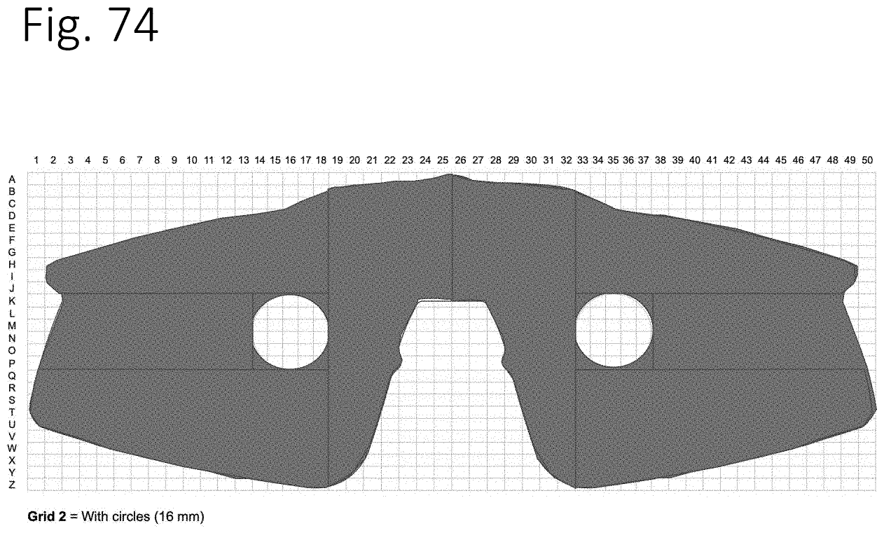

### DETAILED DESCRIPTION OF A PREFERRED EMBODIMENT

The purpose of the glasses is to occlude visual fields that are associated with specific regions of the brain. The occlusions attached to this document are either laser printed on the lens material or a vinyl cling is attached to the glasses. Either method is effective in occluding a specific portion of a visual field. The average interpupillary distance is 63 mm. The distance may vary from 51-74.5 mm. For women the distance averages 53 mm and for men it is 77 mm. The designs attached are multiple examples of how the laser etching, cling or occlusive material is intended to block out certain visual fields associated with the visual perception. The design is based on the attached vertical/horizontal grid system of 24×48. Vertical nomenclature from A to X and horizontal nomenclature from 1 to 48.

The lenses have been divided into the 24×48 square a system where occlusive cling or laser etching may be potentially apply to inhibit certain visual information to access the visual cortex. The lenses are intended to improve human performance by blocking out (occluding) visual input in certain visual networks that are associated with high-level functioning. For example, the drawing below that has the large size bilateral occlusive lenses on the inferior portions of both lenses (Drawing 43), this lens will include information going to the parietal lobes of the brain. The goal of this information is to block out information so that the brain will create more effective networks in acquiring visual information in the peripheral and central field.

Although there are multiple inclusions that occur within each panel of the lenses, they are millions of combinations of occlusions that may be used within this current grid system that also include simple shapes like circles, squares, triangles, or other images (i.e. logos, brands) that will be inclusive to the visual field in each one of the lenses. The attached patterns for the inclusions on the glasses can be transferred over to any type of glasses that an individual wears to improve visual performance. This pattern focuses on occlusion of the visual access as placed on this 12×48 chart. These inclusions can be used with reading glasses, with sport goggles, with performance eyewear and any other kind of eyewear that has lenses on it. Our technology is not about the application technique rather it is the occlusion of the visual quadrants to be able to inhibit visual information from coming to certain visual access points of the brain and visual system. An individual would potentially use the occlusion to limit information from a specific visual field that connects with a corresponding region of the brain. This visual information would otherwise reach the brain and create a demand on the brain to either interpret or inhibit that incoming visual information. It allows the networks of the brain to increase their connectivity because they have been blocked out of this stream of visual information. The goal of these glasses is to improve brain function using the visual system and occlusions.

The inclusions that are sought after in this patent are not limited to any specific color, but rather the occlusion of the visual system as specifically needed by an athlete, someone struggling with a neurological disease, or someone looking to improve their overall brain performance by using the visual system.

I claim:

1. A kit of eyewear comprising:
a plurality of eyewear elements, each having a frame and a lens associated with each eye;
each of the eyewear elements having an occluded portion of at least one lens;
at least some of the eyewear elements having different occlusion areas on the left and right lenses; and
the eyewear elements having different occlusions patterns from each other.
